(19) United States
(12) Patent Application Publication
(10) Pub. No.: US 2024/0381315 A1
(43) Pub. Date: Nov. 14, 2024

(54) METHOD AND DEVICE FOR PAGING FOR USER EQUIPMENT RECEIVING WAKE-UP SIGNAL IN WIRELESS COMMUNICATION SYSTEM

(71) Applicant: Samsung Electronics Co., Ltd., Gyeonggi-do (KR)

(72) Inventors: Seunghoon CHOI, Gyeonggi-do (KR); Hyewon YANG, Gyeonggi-do (KR); Jaewon LEE, Gyeonggi-do (KR)

(21) Appl. No.: 18/660,752

(22) Filed: May 10, 2024

(30) Foreign Application Priority Data
May 12, 2023 (KR) 10-2023-0062002

(51) Int. Cl. H04W 68/02; H04W 52/02; H04W 76/28

(52) U.S. Cl. CPC H04W 68/02; H04W 52/0235; H04W 76/28

(57) ABSTRACT

The disclosure relates to an efficient paging method for receiving a paging by a user equipment (UE) in a wireless communication system, including receiving configuration information related to the paging from a base station by the UE including a wake-up receiver, receiving a wake-up signal for operating the UE in an on state from the base station through the wake-up receiver, and determining a specific paging frame (PF) for receiving the paging, based on the wake-up signal and the configuration information.

### CROSS-REFERENCE TO RELATED APPLICATION(S)

This application is based on and claims priority under 35 U.S.C. § 119 to Korean Patent Application No. 10-2023-0062002, which was filed in the Korean Intellectual Property Office on May 12, 2023, the contents of which are incorporated herein by reference.

### BACKGROUND

### 1. Field

The disclosure relates generally to a wireless communication system, and more particularly, to a method and device for paging for a user equipment (UE) in the wireless communication system.

### 2. Description of Related Art

Fifth generation (5G) mobile communication technology defines a wide frequency band to enable fast transmission speed and new services and may be implemented in frequencies below 6 gigahertz (GHz) such as 3.5 GHZ, as well as in ultra-high frequency bands above 6 GHz, such as 28 GHz and 39 GHz referred to as millimeter wave (mmWave). Sixth generation (6G) mobile communication technology, referred to as a beyond 5G system, is considered to be implemented in terahertz (THz) bands, such as 95 GHz to 3 THz bands, to achieve a transmission speed 50 times faster than 5G mobile communication technology and ultra-low latency reduced by 1/10.

In the early stages of 5G, standardization was conducted on beamforming and massive multiple input multiple output (MIMO) for mitigating propagation pathloss and increasing propagation distance in ultrahigh frequency bands, support for various numerologies for efficient use of ultrahigh frequency resources (e.g., operation of multiple subcarrier gaps), dynamic operation of slot format, initial access technology for supporting multi-beam transmission and broadband, definition and operation of bandwidth part (BWP), new channel coding, such as a low density parity check (LDPC) code for massive data transmission and polar code for high-reliable transmission of control information, layer 2 (L2) pre-processing, and network slicing for providing a dedicated network specified for a specific service, so as to meet performance requirements and support services for enhanced mobile broadband (eMBB), ultra-reliable low-latency communications (URLLC), and massive machine-type communications (mMTC).

Currently, improvement and performance enhancement in the initial 5G mobile communication technology is being discussed considering the services that 5G mobile communication technology has intended to support, and physical layer standardization is underway for technology, such as vehicle-to-everything (V2X) for increasing user convenience and assisting autonomous vehicles in driving decisions based on the position and state information transmitted from voice over new radio (VoNR), NR unlicensed (NR-U) aiming at the system operation matching various regulatory requirements, NR UE power saving, non-terrestrial network (NTN) which is direct communication between UE and satellite to secure coverage in areas where communications with a terrestrial network is impossible, and positioning technology.

Also being standardized are radio interface architecture/protocols for technology of industrial Internet of things (IIoT) for supporting new services through association and fusion with other industries, integrated access and backhaul (IAB) for providing nodes for extending the network service area by supporting an access link with the radio backhaul link, mobility enhancement including conditional handover and dual active protocol stack (DAPS) handover, 2-step random access channel (RACH) for NR to simplify the random access (RA) process, as well as system architecture/service fields for 5G service based architecture or interface for combining network functions virtualization (NFV) and software-defined networking (SDN) technology and mobile edge computing (MEC) for receiving services based on the position of the UE.

As 5G mobile communication systems are commercialized, soaring connected devices would be connected to communication networks so that reinforcement of the function and performance of the 5G mobile communication system and integrated operation of connected devices are expected to be needed. To that end, new research is to be conducted on, e.g., extended reality (XR) for efficiently supporting, e.g., augmented reality (AR), virtual reality (VR), and mixed reality (MR), and 5G performance enhancement and complexity reduction using artificial intelligence (AI) and machine learning (ML), support for AI services, support for metaverse services, and drone communications.

Development of such 5G mobile communication systems may be a basis for multi-antenna transmission technology, such as new waveform for ensuring coverage in 6G mobile communication THz bands, full dimensional MIMO (FD-MIMO), array antenna, and large scale antenna, full duplex technology for enhancing the system network and frequency efficiency of 6G mobile communication technology as well as reconfigurable intelligent surface (RIS), high-dimensional space multiplexing using orbital angular momentum (OAM), metamaterial-based lens and antennas to enhance the coverage of terahertz band signals, AI-based communication technology for realizing system optimization by embedding end-to-end AI supporting function and using satellite and AI from the design stage, and next-generation distributed computing technology for implementing services with complexity beyond the limit of the UE operation capability by way of ultrahigh performance communication and computing resources.

As wireless communication systems develop, there is a need in the art for a method for transmitting and receiving signals between a UE and a base station, including a wake-up receiver, to address excessive UE power consumption and achieve high energy efficiency.

### SUMMARY

The disclosure has been made to address at least the above-mentioned problems and/or disadvantages and to provide at least the advantages described below.

Accordingly, an aspect of the disclosure is to provide an efficient paging method and device for a UE receiving a wake-up signal in a wireless communication system.

An aspect of the disclosure is to provide a paging method and device for a UE including a wake-up receiver in a wireless communication system.

An aspect of the disclosure is to provide a method and device for determining paging resources for a UE including a wake-up receiver in a wireless communication system.

In accordance with an aspect of the disclosure, a method for receiving a paging by a UE in a wireless communication system includes receiving configuration information related to the paging from a base station by the UE including a wake-up receiver, receiving a wake-up signal for operating the UE in an on state from the base station through the wake-up receiver, and determining a specific paging frame (PF) for receiving the paging, based on the wake-up signal and the configuration information.

In accordance with an aspect of the disclosure, a UE in a wireless communication system includes a transceiver, a wake-up receiver; and a processor configured to receive configuration information related to a paging from a base station, receive a wake-up signal for operating the UE in an on state from the base station through the wake-up receiver, and determine a specific PF for receiving the paging, based on the wake-up signal and the configuration information.

### BRIEF DESCRIPTION OF THE DRAWINGS

The foregoing and other aspects, features, and advantages of embodiments herein will become more apparent from the following description with reference to the accompanying drawings, in which:

FIG. 1 illustrates a basic structure of a time-frequency resource region in a wireless communication system according to an embodiment;

FIG. 2 illustrates a time domain mapping structure of a synchronization signal and a beam sweeping operation according to an embodiment;

FIG. 3 illustrates a signal flow for RA according to an embodiment;

FIG. 4 illustrates a signal flow for reporting UE capability information to a base station by a UE according to an embodiment;

FIG. 5 illustrates a state of a UE according to a state of a base station and state switch of the UE and the base station according to an embodiment;

FIG. 6A illustrates a paging reception scheme of a UE including a wake-up receiver according to an embodiment;

FIG. 6B illustrates a paging reception scheme of a UE including a wake-up receiver according to an embodiment;

FIG. 7 illustrates a paging reception scheme of a UE including a wake-up receiver according to an embodiment;

FIG. 8 illustrates a paging reception scheme of a UE including a wake-up receiver according to an embodiment;

FIG. 9 illustrates a paging reception scheme of a UE including a wake-up receiver according to an embodiment;

FIG. 10 illustrates an operation flow of paging reception of a UE including a wake-up receiver according to an embodiment;

FIG. 11 illustrates an operation flow of a base station for paging transmission according to an embodiment;

FIG. 12 illustrates a structure of a UE according to an embodiment; and

FIG. 13 illustrates a structure of a base station according to an embodiment.

### DETAILED DESCRIPTION

The following description with reference to the accompanying drawings is provided to assist in a comprehensive understanding of embodiments of the present disclosure. Accordingly, those of ordinary skill in the art will recognize that various changes and modifications of the embodiments described herein can be made without departing from the scope and spirit of the present disclosure. Descriptions of well-known functions and constructions may be omitted for the sake of clarity and conciseness.

For the same reasons, some elements may be exaggerated or schematically shown. The size of each element does not necessarily reflect the actual size of the element. The same reference numeral is used to refer to the same element throughout the drawings.

The components included herein are represented in singular or plural forms depending on specific embodiments proposed. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

As used herein, the term unit means a software element or a hardware element such as a field-programmable gate array (FPGA) or an application specific integrated circuit (ASIC). A unit plays a certain role. However, unit is not limited to software or hardware. A unit may be configured in a storage medium that may be addressed or may be configured to execute one or more processors. Accordingly, a unit includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the units may be combined into fewer components and units or further separated into additional components and units. The components and units may be implemented to execute one or more central processing units (CPUs) in a device or secure multimedia card. A . . . unit may include one or more processors.

As used herein, each of such phrases as A/B, A or B, at least one of A and B, at least one of A or B, A, B, or C, at least one of A, B, and C, and at least one of A, B, or C, may include all possible combinations of the items enumerated together in a corresponding one of the phrases. Such terms as 1st and 2nd, or first and second may be used to simply distinguish a corresponding component from another and does not limit the components in importance or order.

As used herein, terms for identifying access nodes and for denoting network entities, messages, inter-network entity interfaces, and various pieces of identification information are provided as an example for ease of description. Thus, the disclosure is not limited to the terms, and the terms may be replaced with other terms denoting objects with equivalent technical meanings.

Herein, the terms physical channel and signal may be used interchangeably with data or control signal. For example, physical downlink shared channel (PDSCH) denotes a physical channel where data is transmitted, but PDSCH may also be used to denote data. In other words, the expression transmits a physical channel may be equally interpreted as transmits data or a signal through the physical channel. In addition, UE and transceiver may be used interchangeably with main radio.

Herein, higher signaling refers to a signal transfer method that transfers a signal from the base station to the UE using a physical layer downlink data channel or from the UE to the base station using a physical layer uplink data channel. Higher signaling may also refer to radio resource control (RRC) signaling or media access control (MAC) control element (CE).

Although the disclosure describes various embodiments using terms used in some communication standards such as 3rd generation partnership project (3GPP), this is merely an example for description. The disclosure may be easily modified and applied in other communication systems. UEs may refer to mobile phones, smartphones, IoT devices, sensors, as well as other wireless communication devices.

Hereinafter, the base station may be an entity allocating resource to terminal and may be at least one of gNode B (gNB), eNode B (eNB), Node B, base station (BS), wireless access unit, base station controller, or node over network. The terminal may include UE, mobile station (MS), cellular phone, smartphone, computer, or multimedia system capable of performing communication functions. However, the disclosure is not limited to the above examples. Although LTE, LTE-A, or NR based systems are described as examples herein, the disclosure may also apply to other communication systems with a similar technical background or channel form.

In order to process recently soaring mobile data traffic, the initial standards of the 5th generation (5G) system or the new radio access technology (NR), which is the next-generation communication system after long term evolution (LTE) or evolved universal terrestrial radio access (E-UTRA) and LTE-advanced (LTE-A) or E-UTRA evolution, have been completed. While the conventional mobile communication system focuses on typical voice/data communication, the 5G system aims to meet various services and requirements, such as an enhanced mobile broadband (cMBB) service for enhancing conventional voice/data communication, an ultra-reliable and low latency communication (URLLC) service, and a massive machine type communication (MTC) service supporting a large amount of things communication.

While the legacy LTE and LTE-A system transmission bandwidth per single carrier is limited to up to 20 MHz, the 5G system mainly aims for high-speed data services ranging from several Gbps by utilizing a much wider ultra-wide bandwidth. Accordingly, 5G systems are considering ultra-high frequency bands ranging from several GHz to up to 100 GHz, in which it is relatively easy to secure ultra-wideband width frequencies, as candidate frequencies. Further, it is possible to secure a broadband frequency for a 5G system by relocating or allocating frequencies among frequency bands included in several GHz from hundreds of MHz used in legacy mobile communication systems.

Radio waves in the ultra-high frequency band have a wavelength of several mm and are sometimes called millimeter waves. However, in the ultra-high frequency band, the pathloss of radio waves increases in proportion to the frequency band, and the coverage of the mobile communication system decreases.

In order to overcome the disadvantage of coverage reduction in the ultra-high frequency band, a beamforming technology is applied to increase the arrival distance of radio waves by concentrating the radiation energy of radio waves to a predetermined target point using a plurality of antennas. In other words, in the signal to which the beamforming technology is applied, the beam width of the signal becomes relatively narrow, and radiation energy is concentrated within the narrowed beam width, thereby increasing the radio wave arrival distance. The beamforming technology may be applied to each of the transmission end and the reception end. In addition to the coverage increase effect, the beamforming technology has an effect of reducing interference in areas other than the beamforming direction. In order for the beamforming technology to operate properly, an accurate measurement and feedback method for the transmission/reception beam is required. The beamforming technology may be applied to a control channel or a data channel one-to-one corresponding between a predetermined UE and a base station. Further, beamforming technology for increasing coverage may also be applied to the control channel and data channel for transmitting the common signals transmitted to a plurality of UEs in the system by the base station, e.g., synchronization signal, physical broadcast channel (PBCH), and system information. When the beamforming technology is applied to the common signal, the beam sweeping technology that transmits the signal with the beam direction changed may be additionally applied so that the common signal may reach the UE present at an arbitrary position in the cell.

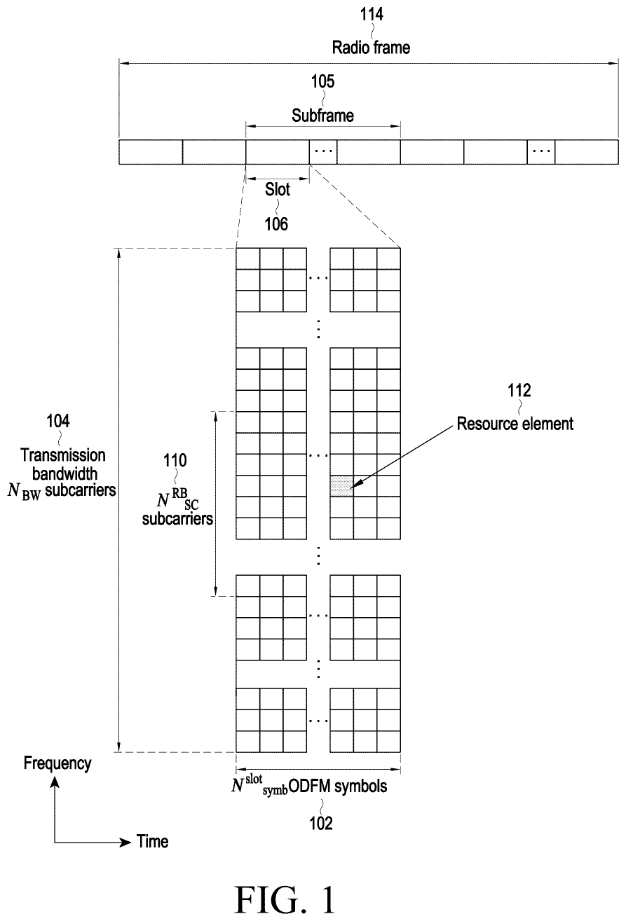

As another requirement of the 5G system, an ultra-low latency service with a transmission delay of about 1 ms between transmission and reception UEs is required. As one way to reduce transmission delay, it is necessary to design a short transmission time interval (TTI)-based frame structure that is shorter than LTE and LTE-A. The TTI is a basic time unit for performing scheduling, and the TTI of the legacy LTE and LTE-A systems is 1 ms corresponding to the length of one subframe. For example, as a short TTI for meeting the requirements for the ultra-low latency service of the 5G system, 0.5 ms, 0.25 ms, 0.125 ms, etc., which are shorter than legacy LTE and LTE-The systems, are possible. FIG. 1 illustrates a basic structure of a time-frequency resource region in a wireless communication system according to an embodiment.

FIG. 1 concerns a radio resource region in which data or control channels are transmitted in a 5G system.

Referring to FIG. 1, the horizontal axis refers to the time domain, and the vertical axis refers to the frequency domain. The minimum transmission unit in the time domain of the wireless communication system is an orthogonal frequency division multiplexing (OFDM) symbol, N_{symb}^{slot} symbols 102 may be gathered to form one slot 106, and Nₛₗₒₜ^{subframe} slots may be gathered to form one subframe 105. The length of the subframe is 1.0 ms, and 10 subframes may be gathered to form a 10 ms frame 114. In the frequency domain, the minimum transmission unit is subcarrier, and the bandwidth of the overall system transmission band may consist of a total of N_{BW} (104) subcarriers.

The basic resource unit in the time-frequency domain is resource element (RE) 112, and this may be represented with an OFDM symbol index and a subcarrier index. A resource block (RB) (or physical resource block (PRB) may be defined as N_{sc}^{RB} contiguous subcarriers 110 in the frequency domain. In the 5G system, N_{sc}^{RB}=12, and the data rate may increase in proportion to the number of RBs scheduled for the UE.

In a wireless communication system, a base station may map data on an RB basis and generally perform scheduling on the RBs that constitute one slot for a given UE. In other words, the basic time unit in which scheduling is performed in the 5G system may be a slot, and the basic frequency unit in which scheduling is performed may be an RB.

The number N_{symb}^{slot} of OFDM symbols is determined according to the length of the cyclic prefix (CP) added to each symbol to prevent interference between symbols. For example, when a normal CP is applied, N_{symb}^{slot}=14, and when an extended CP is applied N_{symb}^{slot}=12. The extended CP is applied to systems where the radio transmission distance is relatively longer than the normal CP, maintaining the orthogonality between symbols. In the normal CP, the ratio between CP length and symbol length is maintained as a constant value, so that the overhead due to the CP may remain constant regardless of subcarrier spacing. In other words, when the subcarrier spacing decreases, the symbol length may increase, and the CP length may also increase accordingly. Conversely, when the subcarrier spacing increases, the symbol length may decrease, and thus the CP length may decrease. The symbol length and the CP length may be inversely proportional to the subcarrier spacing.

In a wireless communication system, various frame structures may be supported by adjusting subcarrier spacing to meet various services and requirements. For example, from the perspective of the operating frequency band, the larger the subcarrier spacing, the more advantageous it is to recover phase noise in a high frequency band. From a transmission time perspective, if the subcarrier spacing is large, the symbol length in the time domain is shortened. Thus, the slot length is shortened, which is advantageous in supporting ultra-low delay services, such as URLLC. From a cell size perspective, the longer the CP length, the larger cells may be supported, so that the smaller the subcarrier spacing, the relatively larger cells may be supported. In mobile communications, cell is a concept that refers to an area covered by one base station.

Subcarrier spacing, CP length, etc. are essential information for OFDM transmission/reception, and seamless transmission/reception is possible only when the base station and UE recognize subcarrier spacing, CP length, etc. as common values.

Table 1 below illustrates the relationship between subcarrier spacing configuration (u), subcarrier spacing (Δf), and CP length supported by the 5G system.

TABLE 1

| μ | Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

Table 2 below illustrates the number (N_{symb}^{slot}) of symbols per slot, the number (Nₛₗₒₜ^{frameμ}) of slots per frame, and the number (Nₛₗₒₜ^{subframeμ}) of slots per subframe, for each subcarrier spacing configuration (μ) in the normal CP.

TABLE 2

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 3 below illustrates the number (N_{symb}^{slot}) of symbols per slot, the number (Nₛₗₒₜ^{frameμ}) of slots per frame, and the number (Nₛₗₒₜ^{subframeμ}) of slots per subframe, for each subcarrier spacing configuration (μ) in the extended CP.

TABLE 3

| μ | N_{symb}^{slot} | Nₛₗₒₜ^{frame, μ} | Nₛₗₒₜ^{subframe, μ} |
|---|---|---|---|
| 2 | 12 | 40 | 4 |

At the early stage of introduction of the 5G system, coexistence or dual-mode operation with the legacy LTE and/or LTE-A (hereinafter, LTE/LTE-A) was expected. As a result, the legacy LTE/LTE-A may provide stable system operation to the UE, and the 5G system may provide enhanced services to the UE. Therefore, the frame structure of the 5G system needs to include at least the LTE/LTE-A frame structure or essential parameter set (e.g., subcarrier spacing=15 kHz).

For example, when comparing a frame structure with a subcarrier spacing configuration μ=0 (hereinafter frame structure A) and a frame structure with a subcarrier spacing configuration μ=1 (hereinafter frame structure B), as compared to frame structure A, frame structure B has the subcarrier spacing and RB size increased in double, and the slot length and symbol length decreased in double. In the case of frame structure B, 2 slots may make up 1 subframe, and 20 subframes may make up 1 frame.

When the frame structure of the 5G system is generalized, the subcarrier spacing, the CP length, the slot length, etc., which are essential parameter sets, are allowed to have an integer multiple relationship therebetween for each frame structure, thereby providing high scalability. A subframe having a fixed length of 1 ms may be defined to represent a reference time unit irrelevant to the frame structure.

The frame structure may be applied in response to various scenarios. From a cell size point of view, the longer the CP length, the larger cell may be supported, so that frame structure A may support a cell relatively larger than frame structure B. From an operating frequency band perspective, the larger the subcarrier spacing, the more advantageous it is to recover the phase noise in a high frequency band, so that frame structure B may support a relatively higher operating frequency than frame structure A. From a service point of view, a shorter length of the slot which is the basic time unit of scheduling may be more advantageous to support an ultra-low latency service, such as URLLC, so that frame structure B may be appropriate for the URLLC service as compared with frame structure A.

Hereinafter, in the description of the disclosure, the uplink (UL) may refer to a wireless link in which the UE transmits data or the control signal to the base station, and the downlink (DL) may refer to a wireless link in which the base station transmits data or the control signal to the UE.

In the initial access step in which the UE accesses the system for the first time, the UE may synchronize downlink time and frequency from a synchronization signal transmitted by the base station through a cell search and obtain a cell ID. The UE may receive a physical broadcast channel (PBCH) using the obtained cell ID and obtain a master information block (MIB) that is essential system information from the PBCH. Additionally, the UE may receive system information (SIB) transmitted by the base station to obtain cell-common transmission/reception-related control information. The cell-common transmission/reception-related control information may include random access (RA)-related control information, paging-related control information, common control information for various physical channels, and the like.

The synchronization signal is a signal that serves as a reference for cell search, and a subcarrier spacing may be applied for each frequency band to be suitable for a channel environment such as phase noise. In the case of the data channel or the control channel, the subcarrier spacing may be adaptively applied according to the service type in order to support various services as described above.

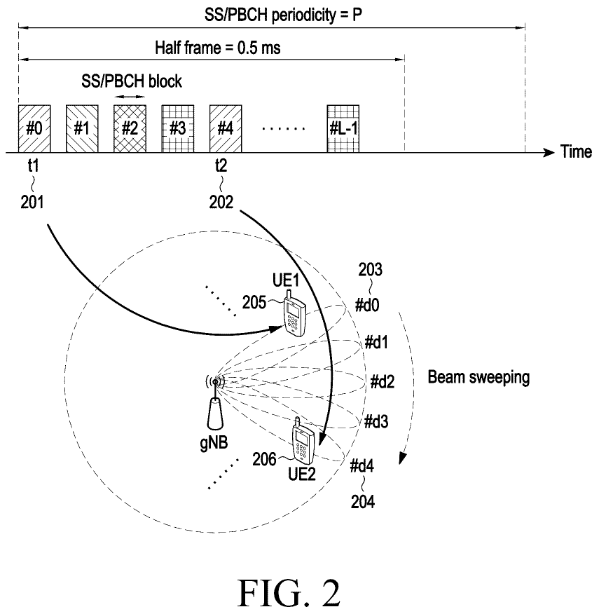

FIG. 2 illustrates a time domain mapping structure of a synchronization signal and a beam sweeping operation according to an embodiment.

Herein, a primary synchronization signal (PSS) isa reference for DL time/frequency synchronization and may provide part of the information for cell ID, and a secondary synchronization signal (SSS) is a reference for DL time/frequency synchronization, provides remaining partial cell ID information, and serves as a reference signal for demodulation of PBCH.

A physical broadcast channel (PBCH) provides an MIB, which is essential system information required data channel and control channel transmission/reception by the UE. The essential system information may include search space-related control information indicating radio resource mapping information about a control channel, scheduling control information for a separate data channel for transmitting system information, and information, such as system frame number (SFN), which is the frame unit index serving as a timing reference.

A synchronization signal/PBCH block or SSB (SS/PBCH block) includes N OFDM symbols and be composed of a combination of the PSS, SSS, and PBCH. In a system to which beam sweeping technology is applied, the SS/PBCH block may be the minimum unit to which beam sweeping is applied. In the 5G system, N=4. The base station may transmit up to L SS/PBCH blocks. The L SS/PBCH blocks may be mapped within a half frame (0.5 ms). The L SS/PBCH blocks may be periodically repeated in units of P, which is a predetermined period. The base station may inform the UE of the period P. If there is no separate signaling for the period P, the UE may apply a previously agreed default value.

FIG. 2 illustrates an example in which beam sweeping applies every SS/PBCH block over time. In FIG. 2, UE1 205 may receive the SS/PBCH block using the beam radiated in direction #d0 203 by the beamforming applied to SS/PBCH block #0 at time t1 201. UE2 206 may receive the SS/PBCH block using the beam radiated in direction #d4 204 by the beamforming applied to SS/PBCH block #4, at time t2 202. The UE may obtain an optimal synchronization signal through the beam radiated from the base station in the direction where the UE is positioned. For example, it may be difficult for UE1 205 to obtain time/frequency synchronization and essential system information from the SS/PBCH block through the beam radiated in direction #d4 away from the position of UE1 205.

In addition to the initial access procedure, the UE may also receive the SS/PBCH block to determine whether the radio link quality of the current cell is maintained at a certain level or higher. Further, in a handover procedure in which the UE moves access from the current cell to the neighboring cell, the UE may determine the radio link quality of the neighboring cell and receive the SS/PBCH block of the neighboring cell to obtain time/frequency synchronization of the neighboring cell.

After the UE obtains MIB and system information from the base station through the initial access procedure, the UE may perform an RA procedure to switch the link with the base station to the connected state (or RRC_CONNECTED state). Upon completing the RA procedure, the UE may switch to the connected state (or RRC_CONNECTED state), and one-to-one communication is possible between the base station and the UE.

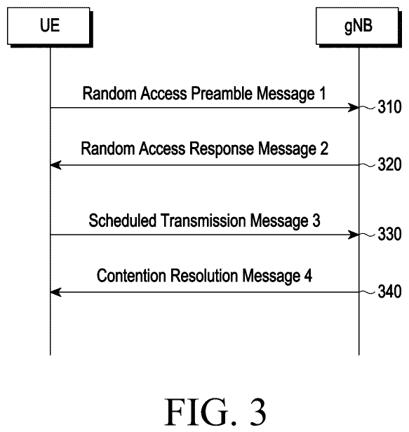

FIG. 3 illustrates a signal flow for RA according to an embodiment.

Referring to FIG. 3, in step 310, the UE may transmit an RA preamble to the base station. In the RA procedure, the RA preamble, which is the first transmission message of the UE, may be referred to as message 1. The base station may measure a transmission delay value between the UE and the base station from the RA preamble and may synchronize uplink. In this case, the UE may arbitrarily select which RA preamble to use within the RA preamble set given by the system information in advance. The initial transmission power of the RA preamble may be determined according to a pathloss between the base station and the UE measured by the UE. The UE may determine the transmission beam direction of the RA preamble from the synchronization signal received from the base station and transmit the RA preamble.

In step 320, the base station may transmit a RA response (RAR) (or message 2) to the RA preamble received in step 310. The base station may transmit an uplink transmission timing adjustment command to the UE based on the transmission delay value measured from the RA preamble. The base station may transmit, to the UE, an uplink resource and power control command to be used by the UE as scheduling information. The scheduling information transmitted by the base station may include control information about the uplink transmission beam of the UE.

When the UE does not receive an RAR (or message 2) which is scheduling information for message 3 from the base station within a predetermined time in step 320, step 310 may be performed again. When step 310 is performed again, the UE may increase the transmission power of the RA preamble by a predetermined step and transmit the increased transmission power (e.g., power ramping), thereby increasing the RA preamble reception probability of the base station.

In step 330, the UE may transmit uplink data (i.e., message 3) including its UE ID to the base station using the uplink resource allocated in step 320. The UE may transmit uplink data including the UE ID to the base station through a physical uplink shared channel (PUSCH). The transmission timing of the uplink data channel for transmitting message 3 may follow the timing control command received from the base station in step 320. The transmission power of the uplink data channel for transmitting message 3 may be determined considering the power control command received from the base station and the power ramping value of the RA preamble in step 320. The uplink data channel for transmitting message 3 may refer to the first uplink data signal that the UE transmits to the base station after transmitting the RA preamble.

In step 340, when the base station determines that the UE has performed RA without conflicting with another UE, the base station may transmit data (i.e., message 4) including the ID of the UE that has transmitted the uplink data in step 330, to the UE. When the signal transmitted by the base station is received from the base station in step 340, the UE may determine that the RA is successful. The UE may transmit hybrid automatic repeat request acknowledgement (HARQ-ACK) information indicating whether message 4 is successfully received to the base station through an uplink control channel (PUCCH).

When the data transmitted by the UE in step 330 and the data of another UE collide with each other and the base station fails to receive the data signal from the UE, the base station may no longer transmit the data to the UE. When the UE fails to receive data transmitted from the base station in step 340 within a predetermined time, the UE may determine that the RA procedure fails and may return to step 310.

When the UE successfully completes the RA procedure, the UE may be switched to a connected state (or RRC_CONNECTED state), and one-to-one communication between the base station and the UE may be possible. The base station may receive the UE capability information from the UE in the connected state or RRC_CONNECTED state, and may adjust scheduling by referring to the UE capability information about the corresponding UE. The UE may inform the base station of whether the UE itself supports a predetermined function, the maximum allowable value of the function supported by the UE, and the like through the UE capability information. Accordingly, UE capability information that each UE reports to the base station may be a different value for each UE.

For example, the UE may report UE capability information including at least one of frequency band related control information supported by the terminal, control information related to channel bandwidth supported by the UE, control information related to maximum modulation method supported by the UE, control information related to maximum beam number supported by the terminal, control information related to maximum layer number supported by the UE, control information related to CSI reporting supported by the UE, control information about whether the UE supports frequency hopping, bandwidth-related control information when carrier aggregation (CA) is supported, and control information about whether cross carrier scheduling is supported when CA is supported.

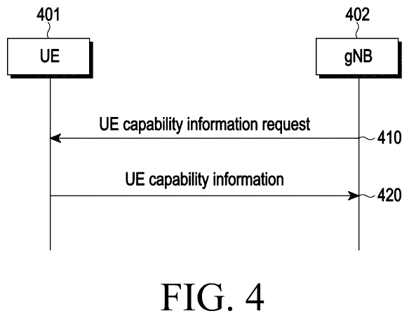

FIG. 4 illustrates a signal flow for a UE to report UE capability information to a base station according to an embodiment.

Referring to FIG. 4, in step 410, the base station 402 may transmit a UE capability information request message to the UE 401. Based on the UE capability information request of the base station 402, the UE 401 may transmit UE capability information to the base station in step 420. The UE 401 may transmit UE capability information to the base station 402 regardless of the UE capability information request of the base station 402.

Based on the transmission/reception process of the UE capability information, the UE connected to the base station may perform one-to-one communication with the base station as a UE in the RRC_CONNECTED state. Conversely, the UE that is not connected may be in the RRC_IDLE state, and the UE in the RRC_IDLE state may perform UE-specific discontinuous reception (DRX) cycle set by higher layer signaling information, receive paging message from a core network, obtain system information, perform measurement operation related to serving cell (or cell being camped on) and cell selection/reselection, perform peripheral cell related measurement operation and cell reselection, and receive paging early indication (PEI).

Herein, higher layer signaling information may correspond to at least one of MIB, SIB or SIB X (X=1, 2, . . . ), RRC) information, or MAC CE.

Layer 1 (L1) signaling information corresponds to at least one or a combination of one or more of the physical downlink control channel (PDCCH), downlink control channel DCI, UE-specific DCI, group common DCI and common DCI. The information transmitted and received by the higher layer signaling information between the base station and the UE may also be transmitted and received by various combinations of the higher layer signaling information and/or L1 signaling information.

The UE may measure the secondary synchronization signal reference signal received power (SS-RSRP) and SS-RSRP levels for the serving cell (or the cell being camped on) at least every M1*N1 DRX cycle and may evaluate the cell selection determination criterion S based on the measured value. When the SSB-based measurement timing configuration (SMTC) cycle is greater than 20 ms, the DRX cycle is less than or equal to 0.64 s, M1=2. Otherwise, M1=1.

N1 may be determined by Table 4 below.

TABLE 4

| DRX | N1 | | | Nₛₑᵣᵥ [number of |
|---|---|---|---|---|
| cycle[s] | FR1 | FR2-1 | FR2-2 | DRX cycles] |
| 0.32 | 1 | 8 | 12 | M1*N1*4 |
| 0.64 | | 5 | 8 | M1*N1*4 |
| 1.28 | | 4 | 6 | N1*2 |
| 2.56 | | 3 | 5 | N1*2 |

The cell selection determination criterion S may be met when Sᵣₓₗₑᵥ>0 corresponding to SS-RSRP and Sdqual>0 corresponding to secondary synchronization signal reference signal received quality (SS-RSRQ) in Equation (1) below.

$${S}_{rxlev} = {Q}_{rxlevmeas} - ( {Q}_{rxlevmin} + {Q}_{rxlevminoffset} ) - {P}_{compensation} - {Q}_{offsettemp} \qquad ( 1 )$$

$${S}_{qual} = {Q}_{qualmeas} - ( {Q}_{qualmin} + {Q}_{qualminoffset} ) - {Q}_{offsettemp}$$

In Equation (1), Qᵣₓₗₑᵥₘₑₐₛ may be the measured SS-RSRP, Q_{qualmeas} may be the measured SS-RSRQ, Qᵣₓₗₑᵥₘᵢₙ may be the magnitude level of the reception signal required by the serving cell to the minimum limit and may be received by the UE as system information, and Q_{qualmin} may be the quality level of the reception signal required by the serving cell to the minimum limit and may be received by the UE as system information. The remaining parameters are presented in the relevant Standard. In determining the measured SS-RSRP, the UE may determine the SS-RSRP of the serving cell by filtering from at least two measurement values separated by at least half of the DRX cycle. In determining the measured SS-RSRQ, the UE may determine the SS-RSRQ of the serving cell by filtering from at least two measurement values separated by at least half of the DRX cycle.

If the UE determines that the serving cell does not meet the cell selection determination criterion S during the continuous DRX cycle of Nₛₑᵣᵥ, the UE may start measuring all neighboring cells other than the serving cell. If the UE does not find a new suitable cell for 10s, the UE may initiate a cell selection procedure for the selected public land mobile network (PLMN).

The UE may monitor a paging occasion (PO) during the DRX cycle. The PO is a set of PDCCH monitoring occasions and may include a plurality of time slots (subframes or OFDM symbols) in which paging control information may be received. The paging frame (PF) is one radio frame 10 ms and may include one or more POs or the start point of the PO.

PF and PO may be determined by Equation (2) below.

$$( SFN + PF\_offset ) mod T = ( T div N ) * ( UE\_ID mod N ) \qquad ( 2 )$$

In Equation (2), the SFN for the PF is determined, wherein pf_offset is the offset for PF determination, T is the DRX cycle, N is the number of PFs per DRX cycle (cell-common, i.e., cell-specific), which is determined by higher layer signaling information, and UE_ID is determined by the core network as the UE ID (5G-S-TMSI (temporary mobile subscriber identity)). PFs determined by N refer to paging frames commonly applied to UEs in the cell and are referred to herein as cell specific PFs.

i_s indicating the PO index is determined by Equation (3) below.

$$i\_s = floor ( UE\_ID / N ) mod Ns \qquad ( 3 )$$

In Equation (3), Ns refers to the number of POs in one PF and is determined by the higher layer signaling information as one of integer values such as 1, 2, 4, . . . , etc.

As an example, when it is assumed that PF_offset=3, T=128, N=T/4=32, and Ns=4, and UE_ID is one in which UE_ID mod 32 is 1, and floor (UE_ID/32) mod 4 is 1, the SFN for PF in Equations (2) and (3) above and i_s indicating the PO index in the PF may be determined in Equation (4) as follows.

$$( SFN + 3 ) mod 128 = ( 128 div 32 ) * ( UE\_ID mod 32 ) = 4 * 1 = 4 , \qquad ( 4 )$$

$$i\_s = floor ( UE\_ID / 32 ) mod 4 = 1$$

Accordingly, the PF which is the paging frame to be received by the UE having the UE_ID may be determined as a radio frame in which the SFN is 1,129,257, . . . among cell specific PFs, and the PO may be determined as the (i_s+1)th PO (the second PO in the above example) among the four POs in the PF. The PO represents a set of PDCCH monitoring occasions (e.g., “S×X” consecutive PDCCH monitoring occasions). Here, “S” may be the number of actually transmitted SSBs determined according to ssb-positionsinburst information indicating the time domain position of the SSB(s) transmitted in the half frame in which the SS/PBCH block is present provided through RRC information in the NR standard, and X may generally be 1.

The paging early indication (PEI) has been introduced to reduce power consumption of the UE while monitoring and receiving the paging control channel and the paging data channel at each DRX cycle. The UE may monitor or receive one PEI occasion (PEI-O) before receiving paging during the DRX cycle. When the UE receives the PEI and the PEI indicates the paging reception subgroup to which the UE belongs, the PO associated with the UE may be monitored. If the UE does not detect the PEI at the PEI occasion or the PEI does not indicate the paging reception subgroup to which the UE belongs, the UE does not need to monitor the associated PO, thereby reducing UE power consumption. The UE may determine the PEI occasion in the following manner. The PEI occasion is separated backward by a subframe offset based on a radio frame of a reference point separated forward by a pei-FrameOffset based on a PF including an associated PO, and the UE may monitor the PEI in the PEI occasion determined by the above scheme. The pei-FrameOffset, the subframe offset, and the like may be determined by higher layer signaling information.

In the 5G system, a UE in a new state referred to as RRC_INACTIVE has been defined to reduce energy and time consumed for initial access of the UE. In addition, the RRC_INACTIVE UE may perform save access stratum (AS) information required for cell access, UE-specific DRX cycle operation set by the RRC layer, set up a radio access network (RAN)-based notification area (RNA) that may be utilized during handover by the RRC layer and perform periodic updates, and a RAN-based paging message monitoring operation transmitted through an active-radio network temporary identifier (I-RNTI).

The UE in the RRC_CONNECTED state may be changed from the RRC_CONNECTED state to the RRC_INACTIVE state or the RRC_IDLE state by receiving the RRC release indication from the base station.

The UE in the RRC_INACITVE or RRC_IDLE state may perform RA to complete all RA procedures to change from RRC_INACTIVE or RRC_IDLE to RRC_CONNECTED.

Downlink control information (DCI) may be transmitted by the base station to the UE through the downlink and may include downlink data scheduling information or uplink data scheduling information for a predetermined UE. In general, the base station may independently perform channel coding for DCI for each UE and then transmit the DCI to each UE through a PDCCH.

The base station may apply to the UE to be scheduled, a DCI format determined according to the purpose such as whether it is scheduling information (downlink assignment) for downlink data, whether it is scheduling information (uplink grant) for uplink data, or whether it is DCI for power control.

The base station may transmit downlink data to the UE through a PDSCH, which is a physical channel for downlink data transmission. The base station may inform the UE of scheduling information such as a specific mapping position in the time and frequency domain of the PDSCH, a modulation scheme, HARQ-related control information, and power control information through the DCI related to downlink data scheduling information among DCIs transmitted through the PDCCH.

The UE may transmit uplink data to the base station through a PUSCH. The base station may inform the UE of scheduling information such as a specific mapping position in the time and frequency domain of the PUSCH, modulation scheme, HARQ-related control information, power control information, etc. through the DCI related to uplink data scheduling information among DCIs transmitted through the PDCCH.

The time-frequency resource to which the PDCCH is mapped may be referred to as a control resource set (CORESET). The CORESET may be configured in some or all frequency resources of a bandwidth supported by the UE in the frequency domain. In the time domain, one or more OFDM symbols may be set, which may be defined as a CORESET length. The base station may configure one or more CORESETs for the UE through higher layer signaling information (e.g., system information, MIB, radio resource control (RRC) signaling, etc.). “The base station configures the CORESET to the UE” may indicate that the base station provides the UE with information such as a CORESET identifier, a frequency position of the CORESET, and a symbol length of the CORESET. The information provided by the base station to the UE to configure the CORESET may include at least some of the information included in Table 5 below.

TABLE 5

| | |
|---|---|
| ControlResourceSet ::= | SEQUENCE { |
| controlResourceSetId | ControlResourceSetId, |
| frequencyDomainResources | BIT STRING (SIZE (45)), |
| duration | INTEGER (1..maxCoReSetDuration), |

(CORESET duration)

| | |
|---|---|
| cce-REG-MappingType | CHOICE { |
| interleaved | SEQUENCE { |
| reg-BundleSize | ENUMERATED {n2, n3, n6}, |
| interleaverSize | ENUMERATED {n2, n3, n6}, |
| shiftIndex | INTEGER(0..maxNrofPhysicalResourceBlocks-1) OPT |

IONAL -- Need S
},

| | |
|---|---|
| nonInterleaved | NULL |

},

| | |
|---|---|
| precoderGranularity | ENUMERATED {sameAsREG-bundle, allContiguousRBs}, |
| tci-StatesPDCCH-ToAddList | SEQUENCE(SIZE (1..maxNrofTCI-StatesPDCCH)) O |

```
F TCI-StateId OPTIONAL, -- Cond NotSIB1-initialBWP
    (QCL configuration information)
    tci-StatesPDCCH-ToReleaseList SEQUENCE(SIZE (1..maxNrofTCI-StatesPDCCH)) OF T
CI-StateId OPTIONAL, -- Cond NotSIB1-initialBWP
    (QCL configuration information)
```

| | |
|---|---|
| tci-PresentInDCI | ENUMERATED {enabled} |

```
    OPTIONAL, -- Need S
    (QCL indicator configuration information in DCI)
```

| | |
|---|---|
| pdcch-DMRS-ScramblingID | INTEGER (0..65535) |

OPTIONAL, -- Need S
}

The CORESET may be constituted of N_{RB}^{CORESET} RBs in the frequency domain, and of N_{symb}^{CORSET} ∈{1,2,3} in the time domain. The NR PDCCH may be constituted of one or more control channel elements (CCEs). One CCE may consist of 6 resource element groups (REGs), and the REG may be defined as 1 RB during 1 OFDM symbol. In one CORESET, REGs may be indexed in a time-first order, starting with REG index 0 from the first OFDM symbol of the CORESET, the lowest RB.

An interleaved scheme and a non-interleaved scheme may be supported as transmission schemes for the PDCCH. The base station may configure the UE with whether to perform interleaving transmission or non-interleaving transmission for each CORESET, through higher layer signaling. Interleaving may be performed in each REG bundle unit. A REG bundle may be defined as a set of one or multiple REGs. The UE may determine a CCE-to-REG mapping scheme in the corresponding CORESET, as shown in Table 6 below, based on whether to perform interleaving or non-interleaving transmission, configured by the base station.

TABLE 6
The CCE-to-REG mapping for a control-resource set can be interleaved or non-interleaved
and is described by REG bundles:

| | |
|---|---|
| - | REG bundle i is defined as REGs {iL,iL+1,...,iL+L−1} where L is the REG bundle size, |
| | i = 0,1,...,N_{REG}^{CORESET} /L − 1, and N_{REG}^{CORESET} = N_{RB}^{CORESET} N_{symb}^{CORESET} is the number of REGs |
| | in the CORESET |
| - | CCE j consists of REG bundles {f(6j/L),f(6j/L+1),...,f(6j/L+6/L−1)} where f(·) is an |
| | interleaver |

For non-interleaved CCE-to-REG mapping, L = 6 and f(x) = x.
For interleaved CCE-to-REG mapping, L ∈ {2,6}for N_{symb}^{CORESET} = 1 and L ∈ {N_{symb}^{CORESET}, 6} for
N_{symb}^{CORESET} ∈ {2,3}. The interleaver is defined by

```
          f(x) = (rC + c + n_{shift}) mod (N_{REG}^{CORESET} /L)
              x = cR + r
              r = 0,1, ... ,R − 1
              c = 0,1, ... ,C − 1
            C = N_{REG}^{CORESET} /(LR)
```

where R∈ {2,3,6}.

The base station may provide configuration information, such as information regarding the symbols where the PDCCH is mapped in the slot and transmission period, to the UE through signaling.

The search space of the PDCCH is described below. The number of CCEs necessary to transmit a PDCCH may be, e.g., 1, 2, 4, 8, or 16 depending on the aggregation level (AL), and different numbers of CCEs may be used for link adaptation of downlink control channel. For example, if AL=L, one downlink control channel may be transmitted via L CCEs. The UE performs blind decoding to detect a signal while being unaware of information for the downlink control channel. Thus, a search space may be defined which indicates a set of CCEs. The search space is a set of candidate control channels constituted of CCEs that the UE needs to attempt to decode on the given aggregation level. Since there are several aggregation levels to bundle up 1, 2, 4, 8, or 16 CCEs, the UE has a plurality of search spaces. A search space set may be defined as a set of search spaces at all set aggregation levels.

The search spaces may be classified into a common search space (CSS) and a UE-specific search space (USS). A predetermined group of UEs or all the UEs may investigate the common search space of the PDCCH to receive cell-common control information, e.g., paging message, or dynamic scheduling for an SIB. For example, the UE may receive scheduling allocation information about PDSCH for system information reception by examining the common search space of PDCCH. In the common search space, since a certain group of UEs or all the UEs need receive the PDCCH, the common search space may be defined as a set of CCEs previously agreed on. The UE may receive scheduling allocation information for the UE-specific PDSCH or PUSCH by inspecting the UE-specific search space of PDCCH. The UE-specific search space may be UE-specifically defined with a function of various system parameters and the identity (ID) of the UE.

The base station may configure, to the UE, configuration information for the search space of the PDCCH using higher layer signaling. For example, the base station may configure the UE with, e.g., the number of PDCCH candidates at each aggregation level L, monitoring period for search space, monitoring occasion of symbol unit in slot for search space, search space type (common search space or UE-specific search space), combination of RNTI and DCI format to be monitored in the search space, and CORESET index to be monitored in the search space. Parameters for the search space for the PDCCH may include information as shown in Table 7 below.

TABLE 7

| SearchSpace ::= | SEQUENCE { | |
|---|---|---|
| searchSpaceId | SearchSpaceId, | |
| controlResourceSetId | ControlResourceSetId | OPTIONAL, -- |

Cond SetupOnly
monitoringSlotPeriodicityAndOffset CHOICE {

| | |
|---|---|
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19), |
| sl40 | INTEGER (0..39), |
| sl80 | INTEGER (0..79), |
| sl160 | INTEGER (0..159), |
| sl320 | INTEGER (0..319), |
| sl640 | INTEGER (0..639), |
| sl1280 | INTEGER (0..1279), |
| sl2560 | INTEGER (0..2559) |

}
OPTIONAL, -- Cond Setup

| | | |
|---|---|---|
| duration | INTEGER | (2..2559) |

OPTIONAL, -- Need R
(monitoring duration)

| | |
|---|---|
| monitoringSymbolsWithinSlot | BIT STRING (SIZE (14)) |

OPTIONAL, -- Cond Setup

| | |
|---|---|
| nrofCandidates | SEQUENCE { |

(number of PDCCH candidate groups per aggregation level)

| | |
|---|---|
| aggregationLevel1 | ENUMERATED {n0, n1, n2, n3, n4, n5, n6, n8}, |
| aggregationLevel2 | ENUMERATED {n0, n1, n2, n3, n4, n5, n6, n8}, |
| aggregationLevel4 | ENUMERATED {n0, n1, n2, n3, n4, n5, n6, n8}, |
| aggregationLevel8 | ENUMERATED {n0, n1, n2, n3, n4, n5, n6, n8}, |
| aggregationLevel16 | ENUMERATED {n0, n1, n2, n3, n4, n5, n6, n8} |

```
    }
  OPTIONAL, -- Cond Setup
```

| | |
|---|---|
| searchSpaceType | CHOICE { |
| common | SEQUENCE { |

(Common search space)

| | |
|---|---|
| dci-Format0-0-AndFormat1-0 | SEQUENCE { |

```
              ...
            }
  OPTIONAL, --Need R
```

| dci-Format2-0 | SEQUENCE { | |
|---|---|---|
| nrofCandidates-SFI | SEQUENCE { | |
| aggregationLevel1 | | ENUMERATED {n1, n2} |

OPTIONAL, -- Need R

| | |
|---|---|
| aggregationLevel2 | ENUMERATED {n1, n2} |

OPTIONAL, -- Need R

| | |
|---|---|
| aggregationLevel4 | ENUMERATED {n1, n2} |

OPTIONAL, -- Need R

| | |
|---|---|
| aggregationLevel8 | ENUMERATED {n1, n2} |

OPTIONAL, -- Need R

| | |
|---|---|
| aggregationLevel16 | ENUMERATED {n1, n2} |

```
  OPTIONAL -- Need R
              },
              ...
            }
  OPTIONAL, -- Need R
```

| | |
|---|---|
| dci-Format2-1 | SEQUENCE { |

```
              ...
            }
  OPTIONAL, -- Need R
```

| | |
|---|---|
| dci-Format2-2 | SEQUENCE { |

```
              ...
            }
  OPTIONAL, -- Need R
```

| dci-Format2-3 | SEQUENCE { | |
|---|---|---|
| dummy1 | | ENUMERATED {sl1, sl2, sl4, sl5, |

sl8, sl10, sl16, sl20} OPTIONAL, -- Cond Setup

| | |
|---|---|
| dummy2 | ENUMERATED {n1, n2}, |

```
              ...
            }
  OPTIONAL -- Need R
          },
```

| | |
|---|---|
| ue-Specific | SEQUENCE { |

(UE-specific search space)

| | |
|---|---|
| dci-Formats | ENUMERATED {formats0-0-And-1-0, |

```
  formats0-1-And-1-1},
            ...,
          }
    }
  OPTIONAL -- Cond Setup2
  }
```

According to the configuration information transmitted to the UE by the base station, the base station may configure one or more search space sets to the UE. The base station may configure search space set 1 and search space set 2 to the UE. Search space set 1 may be configured so that the UE monitors DCI format A, scrambled with X-RNTI, in the common search space, and search space set 2 may be configured so that the UE monitors DCI format B, scrambled with Y-RNTI, in the UE-specific search space.

According to the configuration information transmitted from the base station, one or more search space sets may exist in the common search space or the terminal-specific search space. For example, search space set #1 and search space set #2 may be configured in the common search space, and search space set #3 and search space set #4 may be configured in the UE-specific search space.

In the common search space, the UE may monitor combinations of DCI formats and RNTIs including but not limited to DCI format 0_0/1_0 with CRC scrambled by C-RNTI, CS-RNTI, SP-CSI-RNTI, RA-RNTI, TC-RNTI, P-RNTI, and SI-RNTI, DCI format 2_0 with CRC scrambled by SFI-RNTI, DCI format 2_1 with CRC scrambled by INT-RNTI, DCI format 2_2 with CRC scrambled by transmit power control (TPC)-PUSCH-RNTI and TPC-PUCCH-RNTI, and DCI format 2_3 with CRC scrambled by TPC-SRS-RNTI.

In the UE-specific search space, the UE may monitor combinations of DCI formats and RNTIs including but not limited to DCI format 0_0/1_0 with CRC scrambled by C-RNTI, CS-RNTI, and TC-RNTI, and DCI format 1_0/1_1 with CRC scrambled by C-RNTI, CS-RNTI, and TC-RNTI.

The RNTIs may be defined and used as a Cell RNTI (C-RNTI) for scheduling UE-specific PDSCH or PUSCH, a temporary cell RNTI (TC-RNTI) for scheduling UE-specific PDSCH, a configured scheduling RNTI (CS-RNTI) for scheduling semi-statically configured UE-specific PDSCH, a RA RNTI (RA-RNTI) for scheduling PDSCH in the RA phase, a paging RNTI (P-RNTI) for scheduling PDSCH where paging is transmitted, a system information RNTI (SI-RNTI) for scheduling PDSCH where system information is transmitted, an interruption RNTI (INT-RNTI) for indicating whether to puncture PDSCH, TPC for PUSCH RNTI (TPC-PUSCH-RNTI) for indicating power control command for PUSCH,

TPC for PUCCH RNTI (TPC-PUCCH-RNTI) for indicating power control command for PUCCH, and TPC for SRS RNTI (TPC-SRS-RNTI) for indicating power control command for SRS.

The above-described DCI formats may follow the definitions in Table 8 below.

TABLE 8

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission is |
| | intended for the UE |
| 2_2 | Transmission of TPC commands for PUCCH and PUSCH |
| 2_3 | Transmission of a group of TPC commands for SRS |
| | transmissions by one or more UEs |

The search space of the aggregation level L in CORESET p and the search space set s May be expressed in Equation (5) below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{p , s , max}^{( L )}} ⌋ + {n}_{CI} ) mod ⌊ {N}_{CCE , p} / L ⌋ \} + i \qquad ( 5 )$$

Ini Equation (5), L is an aggregation level,
n_{CI} is a carrier index,
N_{CCE,p} is a total number of CCEs present in CORESET p,
n^{μ}_{s,f} is a slot index,
M^{(L)}_{p,s,max} is a number of PDCCH candidate groups of aggregation level L,
m_{snCI}=0, r of ^{(L)}_{p,s,max}−1 is a PDCCH candidate group index of aggregation level L,
i=0, candid,

$$Y \text{?} = ( A \text{?} \text{?} Y \text{?} ) mod D , Y \text{?} = \text{?} \neq 0 , A \text{?} = 39827 \text{?} A \text{?} = 29829 , A \text{?} = 39839 \text{?} D = 65537 ,$$

$$\text{?} \text{indicates text missing or illegible when filed}$$

nRNTI is a UE identifier, and
Y_{p,n}_{_{s,t}}^{μ} may be 0 in the common search space.

In the UE-specific search space, Y_{p,n}_{_{s,t}}^{μ} may be a value that changes depending on the UE's ID (C-RNTI or ID configured in the UE by the base station) and the time index.

As described above, in order to achieve a high-speed data service ranging from several Gbps in a 5G system, signal transmission/reception with an ultra-wide bandwidth of tens to hundreds of MHz or several GHz may be supported. Ultra-wideband signal transmission/reception may be supported through a single component carrier (CC), or may be supported through carrier aggregation (CA) technology that combines multiple component carriers. When a mobile communication operator fails to secure a frequency of a bandwidth sufficient to provide a high-speed data service as a single component carrier, the carrier aggregation technology may increase the sum of frequency bandwidths by combining each component carrier having a relatively small bandwidth and consequently enable a high-speed data service.

5G systems are designed and developed for all various use cases. In addition to latency, reliability, and availability, energy efficiency of a UE is very important in a 5G system. In the 5G system, the UE charges, e.g., on a weekly or daily basis according to the user's usage time, and generally consumes tens of mW in the RRC_IDLE/RRC_INACTIVE state and hundreds of mW in the RRC_CONNECTED state. Design for extending battery life may be an essential element for enhancing energy efficiency as well as a better user experience. Energy efficiency may be more important for UEs without continuous energy sources (e.g., UEs using small rechargeable and single coin cell batteries). Among 5G use cases, sensors and actuators are widely arranged for monitoring, measuring, and charging. In general, batteries may not be recharged and may be required to last for at least a few years. Further, wearables may include smartwatches, rings, cHealth-related devices, and medical monitoring devices, which are generally difficult for the battery to last up to 1-2 weeks depending on usage time.

According to an embodiment, power consumption of the 5G UE depends on a set length (e.g., a paging cycle) of wake-up periods, and an extended discontinuous reception (eDRX) cycle having a large value may be used to meet a battery life requirement. However, the eDRX method is not suitable for services with low waiting time because the battery life is maintained long based on high waiting time. For example, in the case of fire detection and extinguishing use, the fire shutter may be closed within 1 to 2 seconds from the time when the fire is detected by the sensor, and the sprinkler may be turned on by the actuator. In this case, the waiting time may be important, and the long eDRX cycle as conventional is not suitable because the latency requirement may not be met.

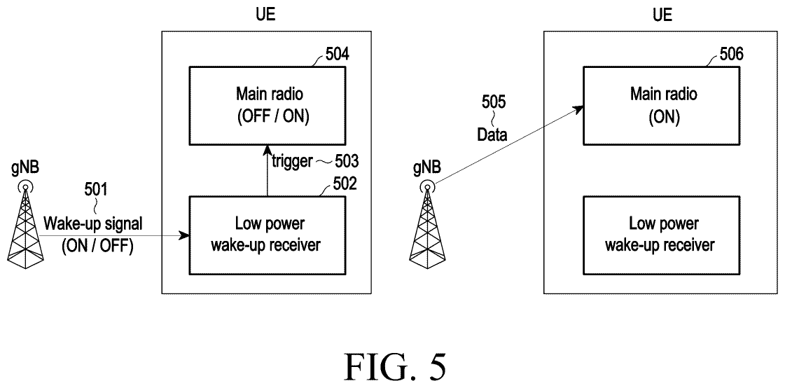

FIG. 5 illustrates a state of a UE according to a state of a base station and state switch of the UE and the base station according to an embodiment. Referring to FIG. 5, state switching of the base station and the UE is described.

The 5G UE may need to periodically wake up once per eDRX cycle, which may control power consumption when there is no signaling or data traffic between the UE and the base station. If the UE may wake up only when triggered, such as paging, power consumption may be drastically reduced. The drastic power consumption reduction method may be achieved by triggering a conventional NR radio using a wake-up signal (WUS) as shown in FIG. 5. Use of a wake-up receiver (WUR), which is a separate receiver capable of monitoring the WUS with ultra-low power, to turn on the main radio only when data transmission/reception is required. The main radio and the WUR may be included in the UE and may include at least one of a transceiver for transmitting and receiving wireless signals, a modem for encoding/decoding the transmitted and received signal, and component(s) consuming power in the UE. Alternatively, the main radio and the WUR may be understood as the UE, in which case the UE may operate to consume only the minimum power for receiving the WUS until the wake-up signal is received. In the disclosure, terms such as UE and transceiver may be used interchangeably with main radio.

In step 501, the base station may transmit a WUS corresponding to ON or OFF to the UE. The WUS indicating ON may trigger an on state in which the main radio operates, and the WUS indicating OFF may trigger an off state in which the main radio does not operate (or operates minimally). Alternatively, the WUS may indicate the ON state in which the main radio operates, and the UE receiving the paging according to the reception of the WUS may perform the paging operation and then switch the main radio back to the OFF state even without receiving the WUS indicating the OFF state of the main radio or a separate signal.

In step 502, the UE may receive the WUS from the base station using the WUR.

In step 503, the UE may trigger the main radio in the OFF or ON state based on the received information indicating that the WUS corresponds to ON or OFF.

In step 504, the UE may wake up the main radio or turn off the main radio based on the WUS. Alternatively, based on the WUS, the main radio may be set to a deep sleep (DS) state or an ultra-deep sleep (UDS) state rather than a completely OFF state. In the main radio, power consumption is reduced in the order of DS state=>UDS state=>OFF state.

In step 505, when data traffic to be transmitted from the base station to the UE occurs and the WUS transmitted from the base station in step 501 is a signal corresponding to ON, in step 506, the main radio of the UE may be ON, and the UE may receive the data transmitted from the base station through the main radio rather than the WUR.

Since the power consumption for monitoring the WUS depends on the hardware module of the WUR used for designing the WUS, detecting and processing signals, the gain may be maximized for IoT use cases (such as industrial sensors and controllers) and various devices (e.g., form factor devices that are sensitive to power consumption and are small).

The UE including the wake-up receiver may report to the base station that the UE has the capability to wake up the main radio using the wake-up receiver or may report to the base station capability information indicating that the UE includes the wake-up receiver.

The UE may report capability information about the wake-up receiver to the base station through the UE capability information reporting procedure of FIG. 4.

Referring back to FIG. 4, the UE receiving the UE capability information request from the base station in step 410 may transmit UE capability information including capability information for the wake-up receiver to the base station in step 420. Alternatively, even when there is no request of step 410 from the base station, it may be possible for the UE to provide capability information about the wake-up receiver to the base station.

Referring back to FIG. 3, the UE may report capability information about the wakeup receiver to the base station through at least one of step 310 of transmitting the RA preamble in the RA procedures of steps 310 to 340 or step 330 of transmitting scheduled transmission (Message 3) according to the RA procedure in the uplink data channel. Information about sets of RA preambles that may be transmitted by the UE including the wake-up receiver may be transmitted to the UE through higher layer signaling information. The UE may select an RA preamble within the set received by the UE and may transmit the RA preamble in step 310 based on the selected RA preamble. After reporting capability information about the wake-up receiver to the base station, the UE may receive information indicating whether to use the wake-up receiver from the base station through the higher layer signaling information or L1 signaling information.

When the base station supports the UE including the wake-up receiver (e.g., when the base station includes hardware capable of transmitting the wake-up signal), the base station may determine whether to use the wake-up receiver after receiving capability information about the wake-up receiver from the UE. The base station may transmit, to the UE, higher layer signaling information and/or L1 signaling information including whether to use the wake-up receiver or configuration information for receiving the wake-up signal. The base station may transmit, to the UE, at least one of indication information indicating that the UE receives the wake-up signal or activates the wake-up receiver or indication information indicating that the base station transmits the wake-up signal. For example, a slot configured by the base station or defined in the relevant Standard after the slot in which the UE wake-up signal is received, the UE may turn off the main radio and may turn on the wake-up receiver for monitoring the wake-up signal. The UE may transmit, to the base station, at least one of feedback information indicating that the wake-up signal indicating whether to use the wake-up receiver is received before the main radio is turned off or feedback information indicating that the main radio is turned off and the wake-up receiver is turned on.

When the base station does not support the UE including the wake-up receiver, the base station may receive capability information about the wake-up receiver from the UE and then transmit a signal indicating that the wake-up receiver may not be used to the UE. In this case, the UE may transmit, to the base station, feedback information indicating that a signal indicating that the wake-up receiver may not be used is received. The UE may perform an operation based on parameters of the conventional power saving method set by the base station using the conventional power saving method (connected mode DRX (C-DRX) or idle mode DRX (I-DRX) such as paging) disclosed in the relevant Standard.

After the procedure for reporting the capability of the UE including the wake-up receiver and receiving information about whether to support (or permit) the wake-up receiver from the base station, the wake-up receiver of the UE may turn on and off the main radio of the UE based on the wake-up signal. The UE may independently turn on/off the main radio, report the capability of the UE having the wake-up receiver, or receive information about whether to support the wake-up receiver from the base station. For example, even when the capability reporting operation of the UE and the authorization procedure for the use of the wake-up receiver are not performed by the base station, the base station may transmit a signal indicating whether to use the wake-up receiver or configuration information for receiving the wake-up signal to the UE. Accordingly, the UE including the wake-up receiver among the UEs receiving the signal from the base station may turn on/off the main radio through the wake-up receiver.

Performing the on/off of the main radio through the wakeup receiver after reporting the capability of the UE and the procedure for permitting the use of the wakeup receiver is performed by the base station may be applied to all or some of all the UEs (e.g., an RRC_CONNECTED UE, an RRC_IDLE/RRC_INACTIVE UE, or a UE (e.g., an RRC_CONNECTED UE) accessing the cell in the cell supported by the base station. When the capability reporting operation of the UE and the base station permitting procedure are not performed, turning on/off the main radio through the wake-up receiver may be applied to the RRC_IDLE/RRC_INACTIVE UE camping on in the cell supported by the base station.

Hereinafter, various embodiments of the disclosure may include at least one of all, some, or combinations of some of, various operations of a UE including a wake-up receiver and a base station supporting the UE.

Hereinafter, the operation of turning on and off the main radio of the UE including the wake-up receiver is described according to various embodiments of the disclosure. Various embodiments of the disclosure may include at least one of all, some, or combinations of some of, various operations of a UE including a wake-up receiver and a base station described below.

When the main radio of the UE is on, the UE may receive a downlink signal (or data) from the base station through the main radio. When the main radio is on, the main radio may be expressed as on or active, and the on or off of the main radio (or the transceiver) is not limited thereto and may be represented as similar or substantially equivalent thereto in meaning. When the main radio is activated, all or some of specific components (e.g., radio frequency (RF) or baseband (BB)) of the main radio are on or active or this may be defined in the relevant Standard. However, The disclosure is not limited to the above description, and when the main radio is activated, parameters equivalent or substantially similar in meaning thereto or performing operations based on the parameters.

Alternatively, the main radio may perform an operation of receiving a specific channel or signal (e.g., an SS/PBCH block including a synchronization signal or a PDCCH including a down-control channel) defined in the relevant Standard.

When the main radio of the UE is off, the UE may be in a sleep period or may not receive a downlink signal (or data) from the base station. When the main radio is off, the main radio may be expressed as off or inactive, but without limitations thereto, may be represented as similar or substantially equivalent thereto in meaning. When the main radio is deactivated, all or some of specific components (e.g., radio frequency (RF) or baseband (BB)) of the main radio are off or inactive or may be defined in the relevant Standard. However, The disclosure is not limited to the above description. For example, when the main radio is deactivated, this may indicate parameters equivalent or substantially similar in meaning thereto or performing operations based on the parameters. Alternatively, the main radio may no longer perform an operation of receiving a specific channel or signal (e.g., an SS/PBCH block including a synchronization signal or a PDCCH including a down-control channel) defined in the relevant Standard.

As described above, to reduce power consumption in the UE, when the UE receives a wake-up signal from the base station (or when the UE receives a wake-up signal indicating the on state), the main radio may be triggered to be turned on through the wake-up receiver, the main radio may be allowed to receive a downlink signal from the base station. When the wake-up signal is not received (or when a wake-up signal indicating the off state is received), the main radio may be turned off. Alternatively, the on/off operation of the main radio based on the reception of the wake-up signal may also be applied to the RA procedure of the UE and the uplink transmission.

In this case, when the UE in the RRC IDLE or RRC INACTIVE state receives the wake-up signal, the UE may omit reception of the PEI described above and may immediately attempt paging reception. In this case, a method for determining a PO and a PF for receiving the paging is required, and the method is described herein. Furthermore, determining the PO and the PF may be performed in the same manner by the base station transmitting paging and the UE receiving the paging. Transmission and reception of paging may be understood as transmission and reception of a paging message.

Herein, the operations or procedures described as being performed by the main radio or the wake-up receiver for the UE including the wake-up receiver (i.e., the UE having the capability to receive a wake-up) are also performed by the UE including the wake-up receiver (i.e., the UE having the capability to receive a wake-up). Herein, the reception of the wake-up signal by the UE may be understood as the reception of the wake-up signal indicating the on state of the main radio by the UE for convenience of description.

The base station may transmit paging in one PF determined based on the transmission of the wake-up signal, and the UE may receive paging in one PF determined based on the reception of the wake-up signal. Alternatively, the base station may transmit paging in a plurality of PFs determined based on transmission of the wake-up signal, and the UE may receive paging in a plurality of PFs determined based on reception of the wake-up signal. The number of the plurality of PFs may be limited to a predetermined number considering power consumption of the UE.

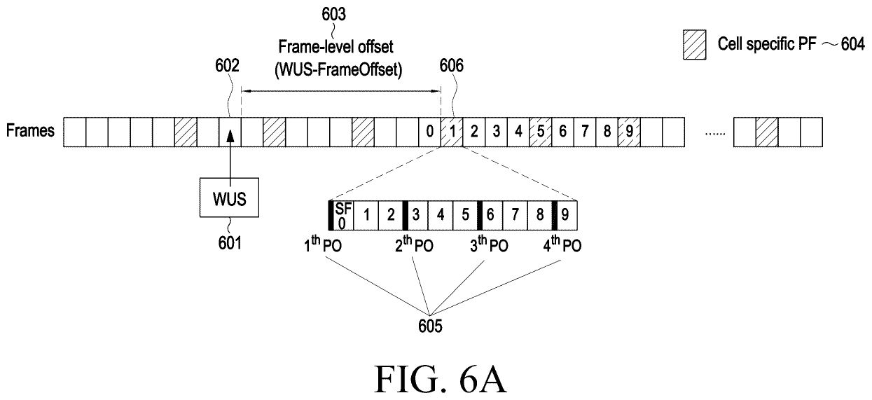

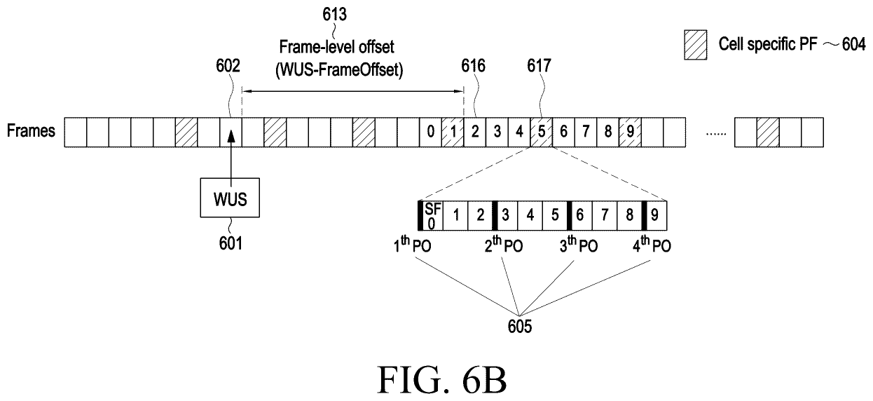

FIG. 6A illustrates a paging reception scheme of a UE including a wake-up receiver according to an embodiment. FIG. 6B illustrates a paging reception scheme of a UE including a wake-up receiver according to an embodiment.

Referring to FIG. 6A and FIG. 6B, a method for determining a PF of a UE including a wake-up receiver within N, i.e., the number of cell specific PFs per DRX cycle, and transmitting and receiving paging in the PF are disclosed. After receiving the wake-up signal, the UE may immediately receive paging without additional delay.

In FIGS. 6A and 6B, since paging frames of all or a predetermined group of UEs in a cell including a UE including a wake-up receiver may be supported within the number of cell-common PFs, it is unnecessary to add resources due to the introduction of additional paging frames of the UE including the wake-up receiver. There is also an advantage that the complexity of scheduling of the base station does not increase due to the paging support for the UE including the wake-up receiver.

A detailed method for determining PF is described in the examples of FIGS. 6A and 6B. Cell specific PFs are shaded by reference numeral 604, and SFN, i.e., a radio frame 602, in which a wake-up signal WUS 601 is received, is illustrated. The WUS-FrameOffsets 603 and 613 may be added/set based on the radio frame 602 in which the wake-up signal 601 is received, and thus the PF may be determined. In other words, the PF may be determined with a time difference as much as the WUS-FrameOffset 603 and 613 at the frame level based on the radio frame 602.

In FIGS. 6A and 6B, the WUS-FrameOffset 603 and 613 may be determined considering a time required for the wake-up receiver of the UE to receive the wake-up signal 601, wake up the main radio (operate in the on state) based on the wake-up signal 601, and receive the paging signal by the main radio, and may be received by higher layer signaling information. Alternatively, the WUS-FrameOffset 603 and 613 may be included in the wake-up signal 601 and may be received by the UE. When the PF determined by the method based on the wake-up signal and the WUS-FrameOffset is not included in the cell-common PF 604, the paging frame may be determined with the cell-common PF that exists next as in the embodiment of FIG. 6B. For convenience, FIGS. 6A and 6B assume that PF_offset=3, T=128, N=T/4=32, and Ns=4, and the UE_ID is one in which UE_ID mod 32 is 1, and floor (UE_ID/32) mod 4 is 1, as in Equations (2) and (3) above.

Referring to FIGS. 6A and 6B, cell-common PFs 604 that are SFNs of each fourth radio frame, i.e., . . . , −3, 1, 5, 9, . . . , are shaded by N=T/4 and PF_offset=3. In the NR system, the radio frame may be set in a round robin scheme from 0 to 1023, and since the number from 0 to 1023 is repeated in the next radio frame 1023, the radio frame-3 means the radio frame 1021 (=−3 mod 1024).

Referring to FIG. 6A, when the PF determined by adding/setting the WUS-FrameOffset 603 with respect to the radio frame 602 in which the wake-up signal 601 is received is 1, the UE may determine SFN=1 as the PF (i.e., PF=1) 606 to receive paging.

Referring to FIG. 6B, when the PF determined by adding/setting the WUS-FrameOffset 613 with respect to the radio frame 602 in which the wake-up signal 601 is received is SFN=2 616 that does not belong to the cell-common PF, the UE may determine SFN=5 617 that is the next cell-common PF 604 as the PF in which the UE needs to receive paging. Since the PF is conventionally determined as a radio frame in which the SFN is 1, 129, 257, . . . by, e.g., (SFN+3) mod 128=(128 div 32)*(UE_ID mod 32)=4*1=4, the SFN=5 may not be determined as the PF in the conventional method. The method as described herein may rapidly receive paging in the UE compared to the conventional method in which the PF is 129.

It may not be expected that the PF in which the UE needs to receive the paging determined by the methods of FIGS. 6A and 6B is not included in the cell-common PF. In other words, the UE may expect that the PF determined by the methods of FIGS. 6A and 6B is always included in the cell-common PF. Accordingly, the base station may perform scheduling so that the PF determined by the methods of FIGS. 6A and 6B is always included in the cell-common PF.

Next, a method for determining the PO 605 in the PFs 606 and 617 determined in the embodiments of FIGS. 6A and 6B is described.

The determination of the PO 605 may be performed in the same manner as a conventional UE that does not include a wake-up receiver. In other words, the PO 605 is determined by the index i_s=floor (UE_ID/N) mod Ns of the PO 605, where Ns means the number of POs in one PF and is determined by the higher layer signaling information. FIGS. 6A and 6B show an example in which Ns=4, i.e., four POs 605 are included in one PF.

Parameters different from those of conventional legacy UEs that do not include a wake-up receiver may be applied to determine the PO 605. For example, instead of Ns applied to the conventional UE, Ns_WUS applied to the UE including the wake-up receiver may be introduced. In other words, the index i_s of the PO 605 is determined by the floor (UE_ID/N) mod Ns_WUS, where Ns_WUS denotes the number of POs in one PF of the UE(s) including the wake-up receiver and may be determined by the higher layer signaling information. The Ns_WUS and Ns may be set to different values or the same value. FIGS. 6A and 6B show an example in which Ns_WUS=4, i.e., four POs 605 are included in one PF.

The PO 605 may be determined by applying the same method as the conventional legacy UE that does not include a wake-up receiver, but a new additional parameter may be added. In other words, the PO 605 may be determined by the index of the PO i_s=floor (UE_ID/N) mod Ns+WUS-offset, where Ns denotes the number of POs in one PF and is determined by higher layer signaling information, and WUS-offset may indicate the offset in the time domain, i.e., the offset in the OFDM symbol unit or the subframe unit. In the Equation of the index of the PO, the “+” operator may be understood to mean the addition operation or that WUS-offset may be additionally considered in i_s determination. The Equation i_s=floor (UE_ID/N) mod Ns+WUS-offset is an example, and various schemes/for determining the PO in the PF at the subframe level or the symbol level in the subframe using at least one of UE_ID and Ns and the WUS-offset may be used. Alternatively, it is also possible to determine the PO by providing separate information directly/indirectly indicating the PO in the PF at the subframe level or the symbol level in the subframe to the UE through the higher layer signaling information without using the Equation for obtaining the i_s. For example, the separate information may be indicated using at least one of WUS-offset and UE_ID.

The above parameters may be transmitted by higher layer signaling information and received by a UE including a wake-up receiver.

Herein, the start position (OFDM symbol or subframe position) and the amount of resources of the PO resources corresponding to i_s in the time domain may be transmitted through higher layer signaling information and received by the UE including the wake-up receiver.

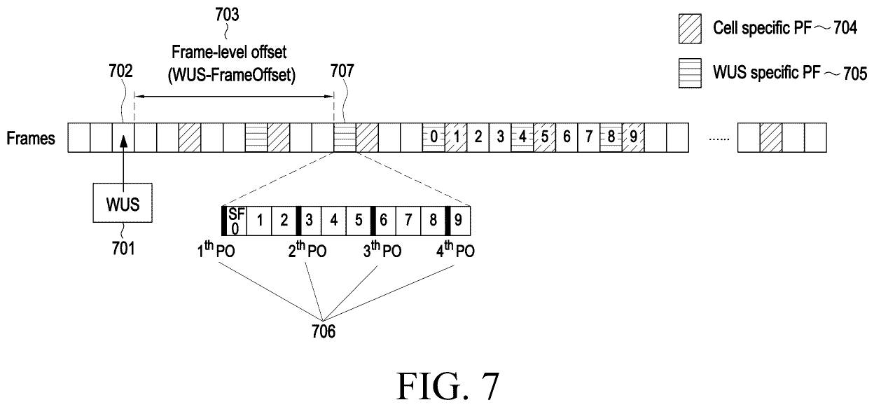

FIG. 7 illustrates a paging reception scheme of a UE including a wake-up receiver according to an embodiment.

Referring to FIG. 7, a method for determining a PF of a UE including a wake-up receiver from among remaining radio frames other than N, i.e., the number of cell specific PFs per DRX cycle, and transmitting and receiving paging in the PF is provided. After receiving the wake-up signal, the UE may immediately receive paging without additional delay. In FIG. 7, paging for the UE including the wake-up receiver may be supported among remaining radio frames other than the number of cell-common PFs applied to the conventional UE in the cell, thereby removing the influence on the paging resource for the conventional UE due to paging support for the UE including the wake-up receiver.

A detailed method for determining PF in the example of FIG. 7 is described. In FIG. 7, a cell-specific PF 704 and a WUS-specific PF 705 are illustrated as shades separated from each other. FIG. 7 illustrates a radio frame 702 of an SFN in which a wake-up signal WUS 701 is received. The WUS-FrameOffset 703 may be added/set with respect to the radio frame 702 in which the wake-up signal 701 is received, so that the PF may be determined. In other words, the PF may be determined with a time difference as much as the WUS-FrameOffset 703 at the frame level with respect to the radio frame 702. The WUS-FrameOffset 703 may be determined considering a time required for the wake-up receiver of the UE to receive the wake-up signal 701, wake up the main radio (operate in the on state) based on the wake-up signal 701, and receive the paging signal by the main radio. The WUS-FrameOffset 703 may be received by higher layer signaling information. Alternatively, the WUS-FrameOffset 703 may be included in the wake-up signal 701 and may be received by the UE.

In FIG. 7, the PF may be determined from among the remaining radio frames other than the cell-common PF 704. To determine the WUS-dedicated PF (WUS specific PF) 705, a UE supporting a wake-up receiver may receive information about a set(s)/list of the WUS-dedicated PF 705, by higher layer signaling information. In FIG. 7, to determine the SFN for the PF, a separate offset may also be applied to the cell-common PF 704 calculated using the conventional scheme (SFN+PF_offset) mod T=(Tdiv N)*(UE_ID mod N) of Equation (2) above. The separate offset may be provided to the UE supporting the wake-up receiver by higher layer signaling information. Alternatively, an Equation obtained by changing some of the parameters of Equation (2) above into parameters for the UE supporting the wake-up receiver may be used. For example, the offset PF_offset_WUS for determining the PF in the UE supporting the wake-up receiver instead of the conventional PF_offset may be provided to the UE by the higher layer signaling information. In this case, Equation (2) above may be newly defined as Equation (6) below.

$$( SFN + PF\_offset \_WUS ) mod T = ( T div N ) * ( UE\_ID mod N ) \qquad ( 6 )$$

In FIG. 7, when the PF determined by the method for determining the PF by adding/setting the WUS-FrameOffset 703 with respect to the radio frame 702 in which the wake-up signal 701 is received is the cell-common PF 704, the paging frame may be determined in the next WUS-dedicated PF 705. The embodiment of FIG. 7 assumes that PF_offset=3, T=128, N=T/4=32, and Ns=4, the UE_ID is one in which UE_ID mod 32 is 1, and floor (UE_ID/32) mod 4 is 1 UE_ID, as described above. FIG. 7 illustrates the cell-common PF 704 which is the SF of each fourth radio frame, i.e., . . . , −3, 1, 5, 9, . . . , by N=T/4 and PF_offset=3. In the NR system, the radio frame may be set in a round robin scheme from 0 to 1023. Since the number from 0 to 1023 is repeated in the next radio frame 1023, the radio frame-3 indicates the radio frame 1021 (=−3 mod 1024). As an example, assuming that the PF_offset_WUS received by the UE is 0, the WUS-dedicated PF 705 set as the SFN of each fourth radio frame, i.e., . . . , −4, 0, 4, 8, . . . , by N=T/4 and PF_offset_WUS-0 in Equation (6) above is illustrated.

Referring to FIG. 7, when the WUS-FrameOffset 703 is added/set with respect to the radio frame 702 in which the wake-up signal 701 is received, and the PF determined to meet Equation (6) above is SFN=−4 (i.e., 1020 (=−4 mod 1024) (707)), the UE may determine SFN=−4 (707) as the PF to receive paging in the WUS-dedicated PF 705. When the PF determined by adding/setting the WUS-FrameOffset with respect to the radio frame 702 in which the wake-up signal 701 is received is 1, the UE may determine 4 which is the PF 705 dedicated to the WUS as the PF in which the UE needs to receive paging. Since the PF is conventionally determined as a radio frame in which the SFN is 1, 129, 257, . . . by, e.g., (SFN+3) mod 128=(128 div 32)*(UE_ID mod 32)=4*1=4, the method in FIG. 7 may quickly receive paging from the UE compared to the conventional scheme in which the PF is 129.

It may not be expected that the PF in which the UE has to receive the paging determined by the method for FIG. 7 is not included in the WUS-dedicated PF 705. In other words, the UE may expect that the PF determined by the method for FIG. 7 is always included in the WUS-dedicated PF 705. Accordingly, the base station may perform scheduling so that the PF determined by the method for FIG. 7 is always included in the WUS-dedicated PF.

Next, a method for determining the PO 706 in the WUS-dedicated PF determined in the embodiment of FIG. 7 is described.

The determination of the PO 706 may be performed in the same manner as a conventional UE that does not include a wake-up receiver. In other words, it is determined by the index i_s=floor (UE_ID/N) mod Ns of the PO 706, where Ns indicates the number of POs in one PF and is determined by the higher layer signaling information. In FIG. 7, Ns=4, i.e., four POs 706 are included in one PF.

Parameters different from those of conventional legacy UEs that do not include a wake-up receiver may be applied to determine PO 706. For example, instead of Ns applied to the conventional UE, Ns_WUS applied to the UE including the wake-up receiver may be introduced. In other words, the index i_s of the PO 706 is determined by the floor (UE_ID/N) mod Ns_WUS, where Ns_WUS denotes the number of POs in one PF of the UE(s) including the wake-up receiver and may be determined by the higher layer signaling information. The Ns_WUS and Ns may be set to different values or to the same value. The example of FIG. 7 shows that Ns_WUS=4, i.e., four POs 706 are included in one PF 705.

The PO may be determined by applying the same method as the conventional legacy UE that does not include a wake-up receiver, but a new additional parameter may be added/set. In other words, it is determined by the index of the PO i_s=floor (UE_ID/N) mod Ns+WUS-offset, where Ns denotes the number of POs in one PF and is determined by higher layer signaling information, and WUS-offset may indicate the offset in the time domain, i.e., the offset in the OFDM symbol unit or the subframe unit. The above parameters may be transmitted by higher layer signaling information and received by a UE including a wake-up receiver. Further, in the embodiments of FIGS. 6A and 6B, various modified examples for determining the PO in the PF at the subframe level or the symbol level in the subframe may be equally applied to the embodiment of FIG. 7.

The start position (OFDM symbol or subframe position) and the amount of resources of the PO resources corresponding to i_s in the time domain may be transmitted through higher layer signaling information and received by the UE including the wake-up receiver.

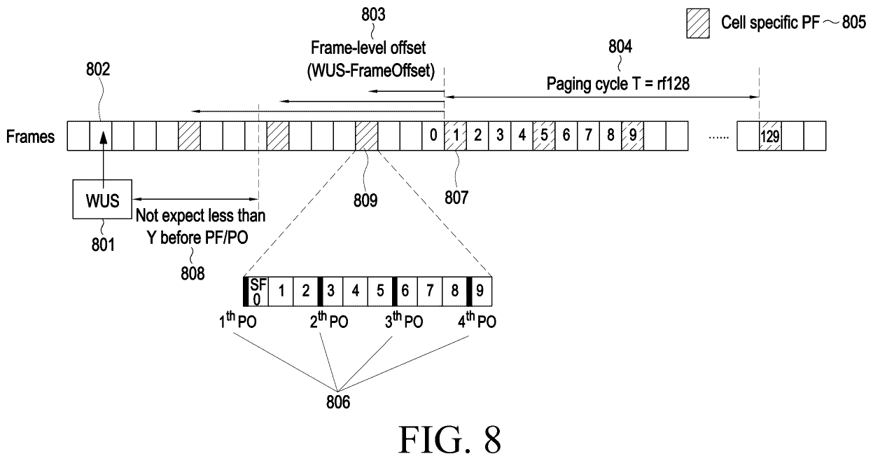

FIG. 8 illustrates a paging reception scheme of a UE including a wake-up receiver according to an embodiment.

Referring to FIG. 8, a method for determining a PF of a UE including a wake-up receiver within N, i.e., the number of cell specific PFs (PFs) per DRX cycle, and transmitting and receiving paging in the PF is provided. After receiving the wake-up signal based on the conventional paging frame determination method, the UE may immediately receive paging without additional delay. In FIG. 8, since paging frames of all or a predetermined group of UEs in a cell including a UE including a wake-up receiver may be supported within the number of cell-common PFs, it is unnecessary to add resources due to the introduction of additional paging frames of the UE including the wake-up receiver. It is advantageous that the complexity of scheduling of the base station does not increase due to the paging support for the UE including the wake-up receiver.

A detailed method for determining PF in the example of FIG. 8 is described. In the examples of FIG. 8, cell specific PFs are shaded by reference numeral 805, and SFN, i.e., a radio frame 802 is received and includes a wake-up signal WUS 801. The PF of the UE including the wake-up receiver may be determined by being deducted from the frame level by the WUS-FrameOffset 803 with respect to the PF (i.e., the paging frame calculated based on the UE_ID of the UE in Equation (2) above) which is the paging frame that, after the UE receives the wake-up signal 801, arrives the earliest. It is assumed that the PF that arrives the earliest in the cell-common PF 805 is SFN=1 807.

The WUS-FrameOffset 803 may be determined considering time (Y) 808 required until the wake-up receiver of the UE receives the wake-up signal 801 and wakes up the main radio (operate in the on state) based on the wake-up signal 801, and the main radio receives the paging signal, and the UE may expect that the time from the radio frame 802 receiving the wake-up signal 801 to the PF determined by the WUS-FrameOffset 803 with respect to the PF 807 arriving the carliest of the UE in the cell-common PF 805 is greater than or equal to Y (808). Alternatively, the UE may not expect that the PF 807 is less than Y (808). The WUS-FrameOffset 803 may be received by higher layer signaling information. Alternatively, the WUS-FrameOffset 803 may be included in the wake-up signal 801 and may be received by the UE. Alternatively, in the WUS-FrameOffset 803, a plurality of candidate values may be set by higher layer signaling information, and one of the candidate values may be included in the wake-up signal 801 to be indicated to the UE.

The embodiment of FIG. 8 assumes that PF_offset=3, T=128 (804), N=T/4=32, and Ns=4, and the UE_ID is one in which UE_ID mod 32 is 1, and floor (UE_ID/32) mod 4 is 1 UE_ID, as described above. The cell-common PF 805 which is the SF of each fourth radio frame, i.e., . . . , −3, 1, 5, 9, . . . , is shaded by N=T/4 and PF_offset=3. In the NR system, the radio frame may be set in a round robin scheme from 0 to 1023, and since the number from 0 to 1023 is repeated in the next radio frame 1023, the radio frame-3 means the radio frame 1021 (=−3 mod 1024). The PF calculated from the UE_ID of the UE in Equation (2) above is equal to (SFN+3) mod 128=(128 div 32)*(UE_ID mod 32)=4*1=4. Accordingly, when it is assumed that SFN=1 is the paging frame 807 that arrives the earliest in the cell-common PF 805, and the WUS-FrameOffset 803 indicated by the base station is, e.g., 4, the UE may determine the SFN 1021 (i.e., the radio frame-3) which is the paging frame 809 determined by being subtracted by the WUS-FrameOffset 803 with respect to the paging frame 807 as the PF in which the UE needs to receive paging.

It may not be expected that the PF in which the UE has to receive the paging determined by the method for FIG. 8 is not included in the cell-specific PF. In other words, the UE may expect that the PF determined by the method for FIG. 8 is always included in the cell-specific PF. Accordingly, the base station may perform scheduling so that the PF determined by the method for FIG. 8 is always included in the cell-specific PF.

The determination of the PO 806 may be performed in the same manner as a conventional UE that does not include a wake-up receiver. In other words, it is determined by the index i_s=floor (UE_ID/N) mod Ns of the PO 806, where Ns indicates the number of POs in one PF and is determined by the higher layer signaling information. The example of FIG. 8 shows that Ns=4, i.e., four POs 805 are included in one PF 604.

Parameters different from those of conventional legacy UEs that do not include a wake-up receiver may be applied to determine the PO 806. For example, instead of Ns applied to the conventional UE, Ns_WUS applied to the UE including the wake-up receiver may be introduced. In other words, the index i_s of the PO 806 is determined by the floor (UE_ID/N) mod Ns_WUS, where Ns_WUS denotes the number of POs in one PF of the UE(s) including the wake-up receiver and may be determined by the higher layer signaling information. The Ns_WUS and Ns may be set to different values or to the same value. FIG. 8 shows an example in which Ns_WUS=4, i.e., four POs 805 are included in one PF.

The PO may be determined by applying the same method as the conventional legacy UE that does not include a wake-up receiver, but a new additional parameter may be added/set. In other words, it is determined by the index of the PO i_s=floor (UE_ID/N) mod Ns+WUS-offset, where Ns denotes the number of POs in one PF and is determined by higher layer signaling information, and WUS-offset may indicate the offset in the OFDM symbol unit or the subframe unit. The above parameters may be transmitted by higher layer signaling information and received by a UE including a wake-up receiver. In FIGS. 6A and 6B, examples for determining the PO in the PF at the subframe level or the symbol level in the subframe may be equally applied to the embodiment of FIG. 8.

The start position (OFDM symbol or subframe position) and the amount of resources of the PO resources corresponding to i_s in the time domain may be transmitted through higher layer signaling information and received by the UE including the wake-up receiver.

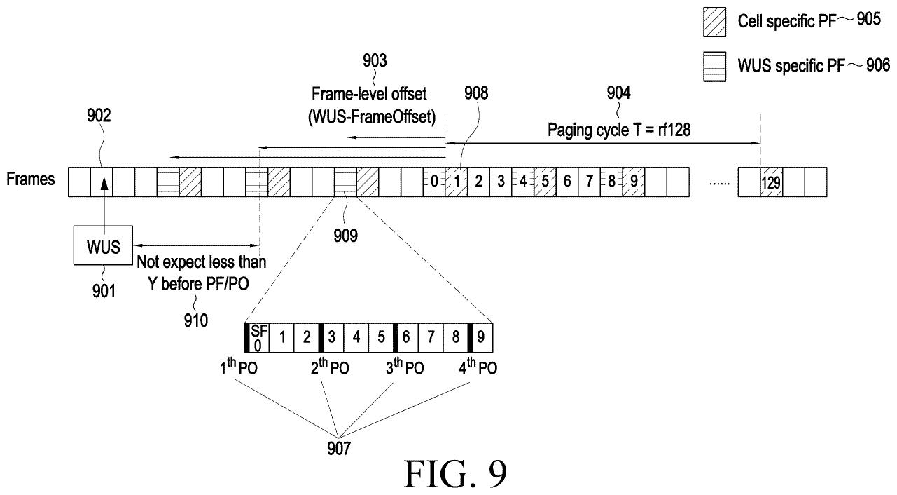

FIG. 9 illustrates a paging reception scheme of a UE including a wake-up receiver according to an embodiment.

Referring to FIG. 9, a method for determining a PF of a UE including a wake-up receiver from the remaining radio frames except for N, i.e., i.e., the number of cell-common PFs per DRX cycle and transmitting and receiving paging in the PF is disclosed. Through the present method, after receiving the wake-up signal based on the conventional paging frame determination method, the UE may immediately receive paging without additional delay. In FIG. 9, paging for the UE including the wake-up receiver may be supported among remaining radio frames other than the number of cell-common PFs applied to the conventional UE in the cell, thereby removing the influence on the paging resource for the conventional UE due to paging support for the UE including the wake-up receiver.

In FIG. 9, a cell-specific PF 905 and a WUS-specific PF 906 are illustrated as shades separated from each other. FIG. 9 illustrates a radio frame 902 of an SFN in which a wake-up signal WUS 901 is received. The PF of the UE including the wake-up receiver may be determined by being deducted from the frame level by the WUS-FrameOffset 903 with respect to the PF that, after the UE receives the wake-up signal 901, arrives the earliest (it is assumed that the PF that arrives the earliest is SFN=1 908).

The WUS-FrameOffset 903 may be determined considering time (Y) 910 required until the wake-up receiver of the UE receives the wake-up signal 901 and wakes up the main radio (operate in the on state) based on the wake-up signal 901, the main radio receives the paging signal, and the UE may expect that the time from the radio frame 902 receiving the wake-up signal 901 to the PF determined by the WUS-FrameOffset 903 with respect to the PF 908 arriving the earliest of the UE is greater than or equal to Y (910). Alternatively, the UE may not expect that the PF 908 is less than Y (910). The WUS-FrameOffset 903 may be received by higher layer signaling information. Alternatively, the WUS-FrameOffset 903 may be included in the wake-up signal 901 and may be received by the UE. Alternatively, in the WUS-FrameOffset 903, a plurality of candidate values may be set by higher layer signaling information, and one of the candidate values may be included in the wake-up signal 901 to be indicated to the UE.

In FIG. 9, the PF may be determined from among the remaining radio frames (e.g., the WUS-dedicated PF 906) other than the cell-common PF 905. As a method for determining a WUS-dedicated PF 906, a UE supporting a wake-up receiver may receive information about a set(s)/list of the WUS-dedicated PF 906, by higher layer signaling information and, to determine the SFN for the PF, a separate offset may also be applied to the cell-common PF 905 calculated using the conventional scheme (SFN+PF_offset) mod T=(Tdiv N)*(UE_ID mod N) of Equation (2) above. The separate offset may be provided to the UE supporting the wake-up receiver by higher layer signaling information. Alternatively, Equation (6) above obtained by changing some of the parameters of Equation (2) above into parameters for the UE supporting the wake-up receiver may be used. In this case, the offset PF_offset_WUS for determining the PF in the UE may be provided by the higher layer signaling information.

The embodiment of FIG. 9 assumes that PF_offset=3, T=128 (904), N=T/4−32, and Ns=4, and the UE_ID is one in which UE_ID mod 32 is 1, and floor (UE_ID/32) mod 4 is 1 UE_ID, as described above. FIG. 9 illustrates the cell-common PF 905 which is the SF of each fourth radio frame, i.e., . . . , −3, 1, 5, 9, . . . , by N=T/4 and PF_offset=3. In the NR system, the radio frame may be set in a round robin scheme from 0 to 1023. Since the number from 0 to 1023 is repeated in the next radio frame 1023, the radio frame-3 means the radio frame 1021 (=−3 mod 1024). As an example, assuming that the PF_offset_WUS received by the UE is “0”, the WUS-dedicated PF 906 set as the SFN of each fourth radio frame, i.e., . . . , −4, 0, 4, 8, . . . , by N=T/4 and PF_offset_WUS-0 in Equation (6) above is illustrated.

The PF calculated from the UE_ID of the UE in Equation (2) above is equal to (SFN+3) mod 128=(128 div 32)*(UE_ID mod 32)=4*1=4. Accordingly, when it is assumed that SFN=1 908 is the paging frame that arrives the earliest, and the WUS-FrameOffset 903 indicated by the base station is 5, the UE may determine the SFN 1020 (i.e., the radio frame-4) (909) which is the paging frame 908 determined by being subtracted by the WUS-FrameOffset 903 with respect to the paging frame 807 as the PF in which the UE needs to receive paging.

In FIG. 9, the WUS-dedicated PF 906 may be determined using Equation (6) above to which the PF_offset_WUS according to the disclosure is applied, and the PF arriving the earliest may be determined using Equation (2) above. The UE may determine the PF 909 determined by subtracting the WUS-FrameOffset 903 from the earliest arriving PF 908 as the PF based on the WUS-FrameOffset 903 set not to be smaller than the time Y 910 required to operate the main radio in the on state and receive the paging signal. In this case, the PF 909 may be determined from the WUS-only PF 906.

It may not be expected that the PF in which the UE has to receive the paging determined by the method for FIG. 9 is not included in the WUS-dedicated PF 906. In other words, the UE may expect that the PF determined by the method for FIG. 9 is always included in the WUS-dedicated PF 906. Accordingly, the base station may perform scheduling so that the PF determined by the method for FIG. 9 is always included in the WUS-dedicated PF.

Next, a method for determining the PO 907 in the WUS-dedicated PF determined in the embodiment of FIG. 9 is described.

The determination of the PO 907 may be performed in the same manner as a conventional UE that does not include a wake-up receiver. In other words, it is determined by the index i_s=floor (UE_ID/N) mod Ns of the PO 907, where Ns means the number of POs in one PF and is determined by the higher layer signaling information. FIG. 9 shows an example in which Ns=4, i.e., four POs 907 are included in one PF.

Parameters different from those of conventional legacy UEs that do not include a wake-up receiver may be applied to determine the PO 907. For example, instead of Ns applied to the conventional UE, Ns_WUS applied to the UE including the wake-up receiver may be introduced. In other words, the index i_s of the PO is determined by the floor (UE_ID/N) mod Ns_WUS, where Ns_WUS denotes the number of POs in one PF of the UE(s) including the wake-up receiver and may be determined by the higher layer signaling information. The Ns_WUS and Ns may be set to different values or may be set to the same value. FIG. 9 illustrates that Ns_WUS=4, i.e., four POs 706 are included in one PF 705.

The PO may be determined by applying the same method as the conventional legacy UE that does not include a wake-up receiver, but a new additional parameter may be added/set. In other words, it is determined by the index of the PO i_s=floor (UE_ID/N) mod Ns+WUS-offset, where Ns denotes the number of POs in one PF and is determined by higher layer signaling information, and WUS-offset may indicate the offset in the OFDM symbol unit or the subframe unit. The above parameters may be transmitted by higher layer signaling information and received by a UE including a wake-up receiver. In FIGS. 6A and 6B, examples for determining the PO in the PF at the subframe level or the symbol level in the subframe may be equally applied to FIG. 9.

The start position (OFDM symbol or subframe position) and the amount of resources of the PO resources corresponding to i_s in the time domain may be transmitted from higher layer signaling information and received by the UE including the wake-up receiver.

Embodiments herein may provide an efficient method and device for determining a reception resource for paging of a UE having a wake-up receiver to address the excessive power consumption issue with the UE and achieve high energy efficiency in a wireless communication system.

When there is a channel or signal to be transmitted to the UE, the base station may transmit a wake-up signal to the UE. The UE or the wake-up receiver may receive a wake-up signal to turn on the main radio. The operation of receiving the wake-up signal may be an instruction to wake up the main radio. The wake-up signal may include K information bits, and information to wake up the main radio may be mapped to the K information bits. For example, when the information bit included in the wake-up signal is 1 bit of information, 1 may indicate ON and 0 may indicate OFF.

In terms of base station transmission, when to transmit a wake-up signal before transmitting a channel or a signal may be predefined. From the UE reception perspective, at which time point to receive the wake-up signal before the channel or signal is received may be predefined.

The UE may transmit, to the base station, information about the time offset required between transmission of the wake-up signal and transmission of the channel/signal, and the base station may configure, to the UE, the time offset between transmission of the wake-up signal and transmission of the channel/signal, based on the received information. The UE may transmit information about the time offset required between transmission of the wake-up signal and transmission of the channel/signal to the base station through the UE capability information reporting procedure, or may transmit the information to the base station through the RA preamble or the uplink data channel in the RA procedure. However, the disclosure is not limited thereto, and the UE may transmit the information about the time offset to the base station through the higher layer signaling information or may transmit the information through various signals.

The base station may configure the information about the time offset between the wake-up signal and the transmission of the channel/signal to the UE through the downlink data channel of the RA response (e.g., message 2) or the RA competition release (e.g., message 4) in the RA procedure. However, the disclosure is not limited thereto, and the base station may configure the information about the time offset to the UE by the higher layer signaling information or through various signals.

When the base station has a periodic channel or a periodic signal to be transmitted to the UE, instead of transmitting a wake-up signal whenever the base station has a channel or a signal to be transmitted, the UE or the wake-up receiver may turn on the main radio according to a periodic channel set from the base station or a period according to configuration information about the periodic signal.

The base station may transmit the wake-up signal only when the periodic channel or the periodic signal is first transmitted and may omit transmission of the wake-up signal when the channel or the signal is repeatedly transmitted thereafter. In this case, the UE or the wake-up receiver may turn on the main radio based on the periodic channel set by the base station or the period according to the configuration information about the periodic signal.

The periodic channel or the type of the periodic signal transmitted/received by the base station and the UE may be predefined or may be set by the base station. The base station may configure the periodic channel or the type of the periodic signal to the UE through an RA response (e.g., message 2) or a downlink data channel of RA competition release (e.g., message 4), or may configure the UE through higher layer signaling information and/or L1 signaling information indicating configuration information for receiving a wake-up signal.

When the UE has a physical RA channel (PRACH), the scheduling request (SR), or the buffer status report (BSR)) to be transmitted to the base station, or when the UE performs the L1/L3-based measurement, the UE or the wake-up receiver may turn on the main radio regardless of the wake-up signal transmitted by the base station.

The wake-up receiver may not receive the wake-up signal and turn on and off the main radio of the UE for uplink transmission or L1/L3-based measurement transmitted by the UE to the base station.

The type of the uplink channel or uplink signal of the UE transmitted irrespective of the operation of receiving the wake-up signal or the measurement based on L1/layer 3 (L3) may be predefined. The type of the uplink channel or the type of the uplink signal or the measurement based on L1/L3 may be configured by the base station. The base station may configure an uplink channel or an uplink signal type or an L1/L3-based measurement to the UE through an RA response (e.g., message 2) or RA competitive release (e.g., message 4) downlink data channel, or may configure the UE through higher layer signaling information and/or L1 signaling information indicating configuration information for receiving a wake-up signal.

When there is a channel or signal to be transmitted to the UE, the base station may transmit a sleep signal to the UE. The UE or the wake-up receiver may receive the sleep signal to turn off the main radio. The operation of receiving the sleep signal itself may be an instruction to put the main radio to sleep. The sleep signal may be configured as a sequence separate from the wake-up signal. The sleep signal may include information mapped to information indicating that the main radio is to be put to sleep in K information bits included in the wake-up signal. For example, when the information is 1-bit information, ‘0’ may indicate OFF and 1 may indicate ON.

The main radio of the UE may be turned off when a set condition is met, such as when the main radio fails to detect or decode a downward control channel, a specific channel, or a signal during a set period. The base station may configure information including a period and a specific channel or signal for the UE to determine to turn off the main radio to the UE through higher layer signaling information indicating configuration information for receiving the wake-up signal and/or L1 signaling information.

The main radio of the UE may always be turned off after receiving one channel or signal. After the wake-up receiver receives the wake-up signal from the base station and the main radio is turned on to receive a channel or signal, the main radio may be turned off. The time required for the main radio to be turned off after the channel or reception is completed may be predefined. The UE may transmit information about a time required until the main radio is turned off to the base station, and the base station may set the required time to the UE based on the received information. The information about the required time transmitted by the UE may be transmitted to the base station through the UE capability information reporting procedure. The information about the required time transmitted by the UE may be transmitted to the base station through an RA preamble or an uplink data channel. However, the disclosure is not limited thereto, and the UE may transmit information about the required time to the base station through the higher layer signaling information. The base station may configure information about the required time to be transmitted to the UE to the UE through a downlink data channel of an RA response (e.g., message 2) or RA competition release (e.g., message 4). However, the disclosure is not limited thereto, and the base station may configure the information about the required time to the UE by the higher layer signaling information.

When the UE or the main radio of the UE is in the RRC_CONNECTED state, the UE may perform PDCCH reception when the main radio wakes up every DRX cycle as a connected mode DRX (C-DRX) is set. When the UE or the main radio of the UE is in the RRC_CONNECTED state, the UE (or the main radio) may be configured to receive a signal indicating whether the UE should receive a PDCCH in the next DRX cycle.

When the main radio is in the RRC_IDLE/RRC_INACTIVE state, the UE may receive a paging PDCCH as an idle mode DRX (I-DRX) is set and the main radio wakes up every paging cycle. When the UE or the main radio of the UE is in the RRC_CONNECTED state, the UE (or the main radio) may be configured to receive a signal indicating to the UE whether to receive a paging PDCCH in the next paging cycle.

Disclosed is a UE operating as a wake-up receiver when indicating ON/OFF based on reception of a wake-up signal of a wake-up receiver and a main radio and an operation according to configuration of C-DRX or I-DRX are mixed. According to an embodiment, the operation of the UE or the main radio of the UE related to the RRC CONNECTED/IDLE/INACTIVE state may be performed in combination with or separately from at least one of various operations according to various embodiments of the disclosure of FIGS. 1 to 9, and may not be an essential component.

When the UE having the wake-up receiver receives the wake-up signal and turns on and off the main radio of the UE, the UE may not set a C-DRX or the I-DRX or an operation according to the setting. In this case, instead of setting the C-DRX or I-DRX and performing operations according to the setting, the UE may turn on the main radio of the UE only when receiving a wake-up signal to wake up the main radio, and may receive a PDCCH and a PDSCH defined or set to be received in the C-DRX or I-DRX, respectively.

When the UE or the main radio of the UE is in the RRC_CONNECTED state and an operation performed by the wake-up receiver is configured or activated by the base station, the UE may turn on the main radio when the wake-up receiver receives a wake-up signal to wake up the main radio, and may also perform an operation related to the set C-DRX from the base station (e.g., the main radio receives a PDCCH within drx_onDurationTimer every DRX cycle). The UE (or main radio) may not perform an operation configured to receive a signal (e.g., DCI format 2_6) indicating to the UE whether to receive a PDCCH in the next DRX cycle. When the UE or the main radio of the UE is in the RRC_IDLE/INACTIVE state and an operation performed by the wake-up receiver is configured or activated by the base station, the UE may turn on the main radio when the wake-up receiver receives a wake-up signal to wake up the main radio, and may also perform an operation related to the I-DRX set by the base station (e.g., the main radio wakes up every paging cycle to receive a paging PDCCH). The UE (or main radio) may not perform an operation configured to receive a signal (e.g., DCI format 2_7) indicating to the UE whether to receive a paging PDCCH in the next paging cycle.

The UE herein may wake up the wake-up receiver and the main radio according to the wake-up signal and turn off the main radio according to the wake-up signal, instead of an operation according to a configuration related to C-DRX or I-DRX. If the operation performed by the wake-up receiver is deactivated by the base station, the operations related to the C-DRX or the I-DRX configured by the base station may be performed again.

When the operation performed by the wake-up receiver of the UE is configured or activated by the base station, and the UE or the wake-up receiver receives the wake-up signal and the main radio is turned on, the UE may be switched to the RRC_CONNECTED state or to the RRC_IDLE or RRC_INACTIVE state. It may be determined to which state the UE may be switched, in advance, or by the higher layer signaling information and/or the L1 signaling information about the wake-up receiver operation configuration from the base station.

As an example where the information about the UE transition is predetermined, the state of the main radio may follow a state immediately before the main radio is turned on and off most recently just before the current turn-on time. As another example where the information about the UE's switching is predetermined, the state of the main radio may not be affected by whether to configure and activate the wake-up receiver operation. For example, the state of the main radio of the UE may be determined only by higher layer signaling information indicating at least one of RRC_CONNECTED, RRC_IDLE, or RRC_INACTIVE, and the UE may determine that the state of the main radio is not switched by whether to configure and activate the wake-up receiver operation.

The wake-up signal may include K information bits, and information about at least one of whether the main radio enters the RRC_CONNECTED state, the RRC_IDLE state, or the RRC_INACTIVE state may be mapped to the K information bits.

When the UE or the main radio of the UE is in the RRC_CONNECTED state based on the determined state of the UE, the main radio may wake up and receive a PDCCH every DRX cycle by the C-DRX configured by the base station, or the UE (or the main radio) may be configured to receive a signal indicating to the user whether the PDCCH should be received in the next DRX cycle from the base station. When an operation for turning off the main radio is performed while the UE receives a PDCCH reception interval, the UE may first perform a procedure for turning off the main radio.

When the UE or the main radio of the UE is in the RRC_IDLE/INACTIVE state, the main radio may wake up and receive the paging PDCCH every paging cycle by the I-DRX configured by the base station. The UE (or main radio) may be configured to receive a signal indicating whether to receive a paging PDCCH in the next paging cycle from the base station. When an operation for turning off the main radio is performed while the UE receives a paging PDCCH (e.g., a paging PDCCH reception interval), the UE may first perform a procedure for turning off the main radio.

The various operations of the UE (or main radios) described above may be performed regardless of the order, and the entity performing the operations may be either or both the UE or/and the main radio.

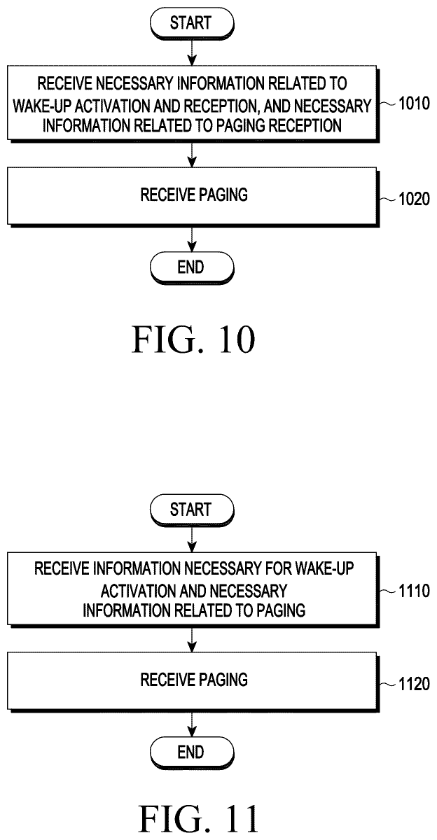

FIG. 10 illustrates an operation flow of paging reception of a UE including a wake-up receiver according to an embodiment.

Referring to FIG. 10, in step 1010, the UE may receive a wake-up activation signal from the base station to receive a wake-up signal using the wake-up receiver, or may receive a wake-up deactivation signal from the base station to no longer receive a wake-up signal using the wake-up receiver. The UE may receive information necessary for receiving the wake-up signal from the base station. The UE may receive a signal indicating whether to use the wake-up receiver or configuration information for receiving the wake-up signal from the base station. The UE may receive information necessary for receiving paging from the base station.

In step 1020, the UE may receive paging according to at least one of the above-described embodiments. The wake-up receiver may be configured or activated to be turned on to search for a wake-up signal. When the wake-up signal is received, the UE may receive paging at a PF/PO determined according to at least one of the above-described embodiments. When the wake-up receiver is not configured or activated, paging may be received at the PF/PO determined based on the paging reception scheme for the conventional legacy UE.

FIG. 11 illustrates an operation flow of a base station for paging transmission according to an embodiment.

Referring to FIG. 11, in step 1110, the base station may transmit a wake-up activation signal to the UE so that the UE receives the wake-up signal using the wake-up receiver, or may transmit a wake-up deactivation signal so that the UE no longer receives the wake-up signal using the wake-up receiver to the UE. The base station may transmit information necessary for receiving the wake-up signal to the UE. In an embodiment, the base station may transmit, to the UE, a signal indicating whether to use the wake-up receiver or configuration information for receiving the wake-up signal. The base station may transmit information necessary for receiving paging to the UE.

In step 1120, the base station may transmit paging. The wake-up receiver of the UE may be configured or activated to search for a wake-up signal and in case that the wake-up signal can be transmitted from the base station and can be received by the UE., paging may be transmitted at a PF/PO determined according to an embodiment herein. When the base station does not configure or activate the wake-up receiver, paging may be transmitted at the PF/PO determined based on the conventional paging reception scheme for the legacy UE.

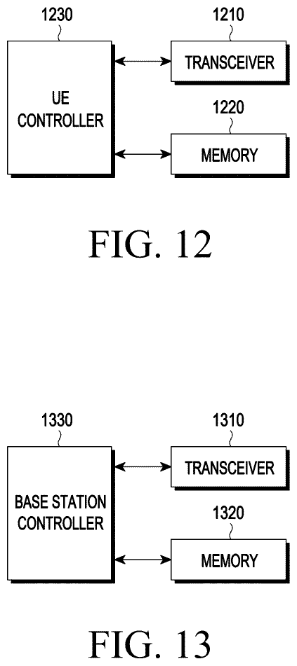

FIG. 12 illustrates a structure of a UE according to an embodiment.

Referring to FIG. 12, a UE may include a transceiver 1210, memory 1220, and a UE controller (or processor 1230). The UE controller 1230, the transceiver 1210, and the memory 1220 may be operated according to the communication method of the UE based on at least one of the embodiments described above with reference to FIGS. 1 to 9. However, the components of the UE are not limited thereto. For example, the UE may include more or fewer components than the above-described components. The UE controller 1230, the transceiver 1210, and the memory 1220 may be implemented in the form of a single chip.

The transceiver 1210 collectively refers to the transmission unit (transmitter) of the UE and the reception unit (receiver) of the UE and may transmit and receive signals to/from the base station or network entity. The transmitted/received signals to/from the base station may include at least one of a paging message, control information and data. To that end, the transceiver 1210 may include a radio frequency (RF) transmitter for frequency-up converting and amplifying signals transmitted and an RF receiver for low-noise amplifying signals received and frequency-down converting the frequency of the received signals. However, this is merely an example of the transceiver 1210, and the components of the transceiver 1210 are not limited to the RF transmitter and the RF receiver.

The transceiver 1210 may include a wired/wireless transceiver and may include various components for transmitting/receiving signals. The transceiver 1210 may receive signals via a radio channel, output the signals to the UE controller 1230, and transmit signals output from the UE controller 1230 via a radio channel. The transceiver 1210 may receive the communication signal, output the signal to the UE controller 1230, and transmit the signal output from the UE controller 1230 to the base station or network entity through a wired/wireless network. The transceiver 1210 may be referred to as a transmission/reception unit for transmitting/receiving radio signals.

The memory 1220 may store programs and data necessary for the operation of the UE. The memory 1220 may store control information or data that is included in the signal obtained by the UE. The memory 1220 may include a storage medium, such as a read only memory (ROM), random access memory (RAM), hard disk, compact disc (CD)-ROM, and digital versatile disc (DVD), or a combination of storage media.

The UE controller 1230 may control a series of processes for the UE to be able to operate according to the above-described embodiments. The UE controller 1230 may include at least one processor. For example, the UE controller 1230 may include at least one of a communication processor (CP) that performs control for communication and an application processor (AP) that controls an upper layer, such as an application program.

FIG. 13 illustrates a structure of a base station according to an embodiment.

Referring to FIG. 13, a base station according to the disclosure may include a transceiver 1310, memory 1320, and a base station controller (or processor 1330). The base station controller 1330, the transceiver 1310, and the memory 1320 may be operated according to the communication method of the base station based on at least one of the embodiments described herein. However, the components of the base station are not limited thereto. For example, the base station may include more or fewer components than the above-described components. The base station of FIG. 13 may be implemented so that all of the functions thereof are divided into a central unit (CU) and a distributed unit (DU) and, in that case, the CU and the DU each may perform at least some functions performed by the base station of FIG. 13. The base station controller 1330, the transceiver 1310, and the memory 1320 of FIG. 13 may be implemented in the form of a single chip.

The transceiver 1310 collectively refers to the receiver and transmitter of the base station and may transmit and receive signals to/from the UE or network entity. In this case, the transmitted/received signals may include at least one of a paging message, control information and data. To that end, the transceiver 1310 may include an RF transmitter for frequency-up converting and amplifying signals transmitted and an RF receiver for low-noise amplifying signals received and frequency-down converting the frequency of the received signals. However, this is merely an example of the transceiver 1310, and the components of the transceiver 1310 are not limited to the RF transmitter and the RF receiver. The transceiver 1310 may include a wired/wireless transceiver and may include various components for transmitting/receiving signals.

The transceiver 1310 may receive signals via a communication channel (e.g., a radio channel), output the signals to the base station controller 1330, and transmit signals output from the base station controller 1330 via a radio channel. The transceiver 1310 may receive the communication signal, output it to the processor and transmit the signal output from the processor to the UE or network entity through the wired/wireless network. The transceiver 1310 may be referred to as a transmission/reception unit for transmitting/receiving radio signals.

The memory 1320 may store programs and data necessary for the operation of the base station. The memory 1320 may store control information or data that is included in the signal obtained by the base station. The memory 1320 may include a storage medium, such as ROM, RAM, hard disk, CD-ROM, and DVD, or a combination of storage media.

The base station controller 1330 may control a series of processes for the base station to be able to operate according to the above-described embodiments. The base station controller 1330 may include at least one processor.

The methods herein may be implemented in hardware, software, or a combination of hardware and software.

When implemented in software, there may be provided a computer readable storage medium storing one or more programs (software modules). One or more programs stored in the computer readable storage medium are configured to be executed by one or more processors in an electronic device. One or more programs include instructions that enable the electronic device to execute methods according to the embodiments described in the specification or claims of the disclosure.

The programs (software modules or software) may be stored in RA memories, non-volatile memories including flash memories, read-only memories (ROMs), electrically erasable programmable read-only memories (EEPROMs), magnetic disc storage devices, compact-disc ROMs, digital versatile discs (DVDs), or other types of optical storage devices, or magnetic cassettes. Or, the programs may be stored in a memory constituted of a combination of all or some thereof. As each constituting memory, multiple ones may be included.

The programs may be stored in attachable storage devices that may be accessed via a communication network, such as the Internet, Intranet, local area network (LAN), wide area network (WLAN), or storage area network (SAN) or a communication network configured of a combination thereof. The storage device may connect to the device that performs embodiments of the disclosure via an external port. A separate storage device over the communication network may be connected to the device that performs embodiments of the disclosure.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). It should also be noted that in some replacement embodiments, the functions mentioned in the blocks may occur in different orders. For example, two blocks that are consecutively shown may be performed substantially simultaneously or in reverse order depending on corresponding functions.

While the disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A method for receiving a paging by a user equipment (UE) in a wireless communication system, the method comprising:
receiving configuration information related to the paging from a base station by the UE including a wake-up receiver;
receiving a wake-up signal for operating the UE in an on state from the base station through the wake-up receiver; and
determining a specific paging frame (PF) for receiving the paging, based on the wake-up signal and the configuration information.

2. The method of claim 1,
wherein the specific paging frame is included in cell-specific PFs including first paging frames, and
wherein the specific paging frame is determined as a first paging frame having a time difference as large as a frame offset included in the configuration information from a radio frame in which the wake-up signal is received.

3. The method of claim 2,
wherein in case that the first paging frame is not included in the cell-specific PFs, the specific paging frame is determined as a second paging frame adjacent to the first paging frame in the cell-specific PF.

4. The method of claim 1,
wherein the specific PF is included in a dedicated PF related to the wake-up signal and includes second PFs that are distinguished from cell-specific PFs including first PFs, and
wherein the specific PF is determined as a PF having a time difference as large as a frame offset included in the configuration information in the dedicated PF from a radio frame in which the wake-up signal is received.

5. The method of claim 4,
wherein a time obtained by subtracting the frame offset from the first PF is set to be greater than or equal to a time required for the UE to receive the paging after the UE is operated based on the wake-up signal.

6. The method of claim 4,
wherein the dedicated PF associated with the wake-up signal is determined based on a specific offset for determining the specific PF in the UE supporting the wake-up receiver, and
wherein the specific offset is received through the configuration information.

7. The method of claim 6, wherein the dedicated PF is determined using the following Equation:
(SFN+PF_offset_WUS)mod T=(T div N)*(UE_ID mod N),
wherein PF_offset_WUS is the specific offset, T is a DRX cycle, N is a number of PFs per DRX cycle, and UE_ID is an identity of the UE.

8. The method of claim 1,
wherein the specific PF is included in cell-specific PFs including first PFs, and
wherein the specific PF is determined as a second PF obtained by subtracting a frame offset included in the configuration information from a first PF arriving earliest in the cell-specific PFs among PFs calculated using identification information of the UE.

9. The method of claim 1,
wherein the specific PF is included in a dedicated PF, related to the wake-up signal, including second PFs, which are distinguished from cell-specific PFs including first PFs, and
wherein the specific PF is determined as a second PF obtained by subtracting a frame offset included in the configuration information from a first PF arriving earliest in the cell-specific PFs among PFs calculated using identification information of the UE.

10. The method of claim 1,
wherein a paging occasion for receiving the paging in the specific PF is determined at a subframe level or a symbol level in the subframe based on information included in the configuration information.

11. A user equipment (UE) in a wireless communication system, comprising:
a transceiver;
a wake-up receiver; and
a processor configured to:
receive configuration information related to a paging from a base station;
receive a wake-up signal for operating the UE in an on state from the base station through the wake-up receiver; and
determine a specific paging frame (PF) for receiving the paging, based on the wake-up signal and the configuration information.

12. The UE of claim 11,
wherein the specific PF is included in cell-specific PFs including first PFs, and
wherein the processor is further configured to determine the specific PF as a first PF having a time difference as large as a frame offset included in the configuration information from a radio frame in which the wake-up signal is received.

13. The UE of claim 12,
wherein in case that the first PF is not included in the cell-specific PF, the processor is further configured to determine the specific PF as a second PF adjacent to the first PF in the cell-specific PFs.

14. The UE of claim 11,
wherein the specific PF is included in a dedicated PF related to the wake-up signal including second PFs that are distinguished from cell-specific PFs including first PFs, and
wherein the processor is further configured to determine the specific PF as a PF having a time difference as large as a frame offset included in the configuration information in the dedicated PF from a radio frame in which the wake-up signal is received.

15. The UE of claim 14,
wherein a time obtained by subtracting the frame offset from the first PF is set to be greater than or equal to a time required for the UE to receive the paging after the UE is operated based on the wake-up signal.

16. The UE of claim 14,
wherein the dedicated PF associated with the wake-up signal is determined based on a specific offset for determining the specific PF in the UE supporting the wake-up receiver, and
wherein the specific offset is received through the configuration information.

17. The UE of claim 16, wherein the dedicated PF is determined using the following Equation:
(SFN+PF_offset_WUS)mod T=(T div N)*(UE_ID mod N),
wherein PF_offset_WUS is the specific offset, T is a DRX cycle, N is a number of PFs per DRX cycle, and UE_ID is an identity of the UE.

18. The UE of claim 11,
wherein the specific PF is included in cell-specific PFs including first PFs, and
wherein the processor is further configured to determine the specific PF as a second PF obtained by subtracting a frame offset included in the configuration information from a first PF arriving earliest in the cell-specific PFs among PFs calculated using identification information about the UE.

19. The UE of claim 11,
wherein the specific PF is included in a dedicated PF related to the wake-up signal including second PFs that are distinguished from cell-specific PFs including first PFs, and
wherein the processor is further configured to determine the specific PF as a second PF obtained by subtracting a frame offset included in the configuration information from a first PF arriving earliest in the cell-specific PFs among PFs calculated using identification information of the UE.

20. The UE of claim 11,
wherein a paging occasion for receiving the paging in the specific PF is determined at a subframe level or a symbol level in the subframe based on information included in the configuration information.
